(19) United States
(12) Patent Application Publication
(10) Pub. No.: US 2007/0274747 A1
(43) Pub. Date: Nov. 29, 2007

(54) Image-forming apparatus, image-forming method and toner

(75) Inventors: Masatoshi Kimura, Kanagawa (JP); Yuichi Yashiki, Kanagawa (JP); Hideki Kashimura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/604,048

(22) Filed: Nov. 24, 2006

(30) Foreign Application Priority Data
May 25, 2006 (JP) 2006-145680

(51) Int. Cl. G03G 15/01

(52) U.S. Cl. 399/302

(57) ABSTRACT

An image-forming apparatus including: a first image-forming unit using a color forming control toner, a first image carrier, a first toner image-forming unit, a color forming information-applying unit, and a first transfer unit; a second image-forming unit using a black coloring toner, a second image carrier, a second toner image-forming unit, and a second transfer unit; an intermediate transfer body; a third transfer unit; a fixing unit; and a color forming unit.

### BACKGROUND

(1) Technical Field

The present invention relates to an image-forming apparatus, and an image-forming method, and a toner.

(2) Related Art

In a recording apparatus of obtaining color images by an electron photographic system, conventionally color images are obtained by development of three primary colors according to image data and superimposing these toner images in sequence. As the specific constitution of apparatus, there are known a so-called four-cycle apparatus of developing a latent image formed by an image-forming method on one photoconductor drum with every color, and repeating to transfer a developed image to a transfer member to obtain a color image, and a tandem apparatus of moving a transfer member with a photoconductor drum and a developing apparatus with every image formation unit of each color, and transferring a toner image continuously in sequence to obtain a color image.

Having plural developing apparatus with every color is common to these recording apparatus. Accordingly, four developing apparatus of black added to three primary colors are necessary in ordinary color image formation. Further, in a tandem apparatus, four photoconductor drums are necessary to respective four developing apparatus, and a unit for conforming synchronism of these four image-forming units is necessary, so that a large sized apparatus and cost increase are inevitable.

In this connection, (see (see,).

### SUMMARY

According to an aspect of the invention, there is provided an image-forming apparatus including:

a first image-forming unit using a color forming control toner that is controlled to maintain the state of color forming or non-color forming by the application of color forming information by light, including a first image carrier, a first toner image-forming unit that forms a first toner image on the surface of the first image carrier with a first developer containing the color forming control toner, a color forming information-applying unit that applies color forming information by light to the first toner image, and a first transfer unit that transfers the first toner image formed on the surface of the first image carrier to the surface of an intermediate transfer body,

a second image-forming unit using a black coloring toner, including a second image carrier, a second toner image-forming unit that forms a second toner image on the surface of the second image carrier with a second developer containing the black coloring toner, and a second transfer unit that transfers the second toner image formed on the surface of the second image carrier to the surface of an intermediate transfer body,

an intermediate transfer body to which the first toner image and the second toner image respectively formed in the first image-forming unit and the second image-forming unit are transferred,

a third transfer unit that transfers the first toner image and the second toner image transferred to the surface of the intermediate transfer body to a recording medium,

a fixing unit that fixes the first toner image and the second toner image transferred to the surface of the recording medium, and

a color forming unit that develops the color of the first toner image that is applied with the color forming information.

### BRIEF DESCRIPTION OF THE DRAWINGS

Exemplary embodiments of the invention will be described in detail based on the following figures, wherein:

FIG. 1 is a schematic block diagram showing an image-forming apparatus related to a first exemplary embodiment;

FIG. 2 is a circuit block diagram of printing controller;

FIG. 3 is a schematic block diagram showing another example of the image-forming apparatus related to the first exemplary embodiment;

FIG. 4 is a schematic block diagram showing an image-forming apparatus related to a second exemplary embodiment;

FIG. 5 is a view showing the construction of a photoconductor;

FIG. 6A is a view showing the state of performing exposure to form an electrostatic latent image on a photoconductor;

FIG. 6B is a view showing the state of a toner image formed on the photoconductor; and

FIG. 6C is a view showing the state of performing exposure to apply color forming information to the photoconductor;

FIG. 7 is a view showing the state of performing exposure to apply color forming information to the photoconductor;

FIG. 8 is a schematic block diagram showing an image-forming apparatus related to a third exemplary embodiment; and

FIGS. 9A and 9B are views explaining the mechanism of color development of a toner, wherein FIG. 9A is a view showing a colored area; and FIG. 9B is an enlargement of the colored area.

### DETAILED DESCRIPTION

The invention will be described with reference to figures. Incidentally, members having substantially the same function are marked with the same sign throughout the figures, and duplicate explanation is sometimes omitted.

### First Exemplary Embodiment

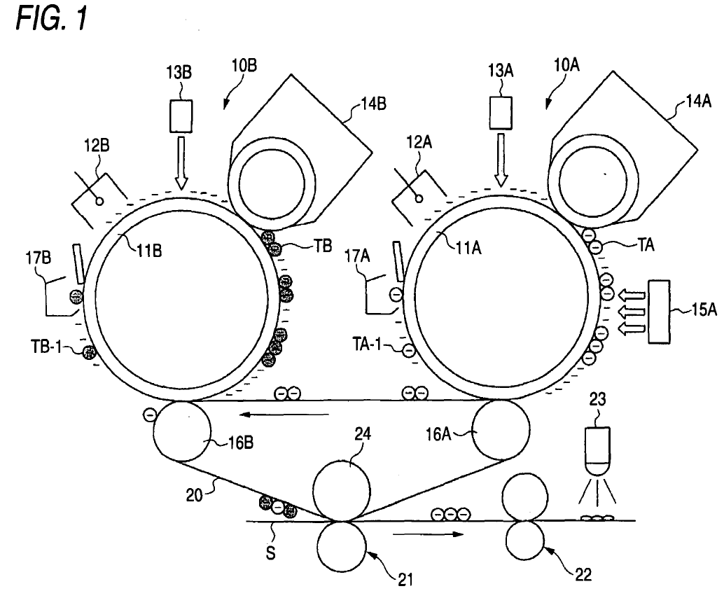

FIG. 1 is a schematic block diagram showing an image-forming apparatus related to a first exemplary embodiment.

As shown in FIG. 1, the image-forming apparatus related to the first exemplary embodiment is equipped with first image-forming unit 10A to form first toner image TA with a color forming control toner, second image-forming unit 10B to form second toner image TB with a black coloring toner, intermediate transfer belt 20 to which each toner image formed in each unit is transferred, third transfer apparatus 21 (a third transfer unit) to transfer the toner images to the surface of recording medium S, fixing apparatus 22 to fix toner images transferred to the surface of recording medium S with at least one of heat and pressure, and photo-irradiation apparatus 23 (a photo-irradiation unit) on the downstream of fixing apparatus 22 to perform photo-irradiation of recording medium S to immobilize the developed color of first toner image TA. Fixing apparatus 22 doubles as a color forming apparatus (a color forming unit) to develop the color of first toner image TA.

First image-forming unit 10A is equipped with first photoconductor 11A (a first image carrier), and around 11A are arranged first charger 12A (a first charging unit) for uniformly negatively charging first photoconductor 11A, first exposing apparatus 13A (a first exposing unit) to expose the surface of first photoconductor 11A according to image data to form an electrostatic latent image, first developing apparatus 14A (a first developing unit) to develop the electrostatic latent image with a first developer containing a negatively charged color forming controlcolor foming control toner to form first toner image TA, color forming information-applying apparatus 15A (a color forming information-applying unit) to apply color forming information to first toner image TA, first transfer apparatus 16A (a first transfer unit) to transfer first toner image TA to the surface of intermediate transfer belt 20, and first cleaning apparatus 17A to remove residual toner TA-1 remaining on first photoconductor 11A after transfer.

On the other hand, second image-forming unit 10B is equipped with second photoconductor 11B (a second image carrier), and around 11B are arranged second charger 12B (a second charging unit) for uniformly negatively charging second photoconductor 11B, second exposing apparatus 13B (a second exposing unit) to expose the surface of second photoconductor 11B according to image data to form an electrostatic latent image, second developing apparatus 14B (a second developing unit) to develop the electrostatic latent image with a second developer containing a negatively charged black coloring toner to form second toner image TB, second transfer apparatus 16B (a second transfer unit) to transfer second toner image TB to the surface of intermediate transfer belt 20, and second cleaning apparatus 17B to remove residual toner TB-1 remaining on second photoconductor 11B after transfer.

Intermediate transfer belt 20 is strained by first transfer apparatus 16A and second transfer apparatus 16B arranged opposite to the photoconductors via intermediate transfer belt 20 and backup roll 24 arranged opposite to third transfer apparatus 21 via intermediate transfer belt 20.

The black coloring toner is a toner containing a conventional black colorant (e.g., carbon black, copper oxide, manganese dioxide, aniline black, activated carbon, nonmagnetic ferrite, magnetite, etc.).

On the other hand, when every particle of the color forming control toner is exposed with light of different wavelength, the color forming control toner has a function of maintaining the state of developing the color corresponding to the wavelength or not developing the color (non-color development). That is, the color forming control toner has in the inside thereof a color developable material capable of developing color (and a color developing part containing the material) by the application of color forming information by light, and the color forming control toner is controlled to maintain the state of color development or non-color development by the application of color forming information by light.

Here, “the application of color forming information by light” means to selectively apply one or more lights of specific wavelengths to desired regions of the toner image or to apply no light for the purpose of controlling the state of color development/non-color development and the tone of developed color with every individual toner particle unit constituting the toner image.

Such color forming control toners are not especially restricted so long as they can reveal the function, and the toners disclosed, e.g., in JP-A-63-311364 and JP-A-2003-330228, and the later-described toners that may be used in the exemplary embodiment of the invention can be exemplified.

In the image-forming apparatus in the first exemplary embodiment, in first image-forming unit 10A, after first photoconductor 11A is uniformly negatively charged with the color forming control toner, negatively charged first photoconductor 11A is subjected to exposure by logical sum of image-forming data of three colors of, e.g., cyan (C), magenta (M) and yellow (Y), to form an electrostatic latent image on first photoconductor 11A, and then the latent image is developed with a first developer containing the negatively charged color forming controltoner to form first toner image TA (a first toner image forming process). In the next place, first toner image TA is exposed with the light of wavelength according to color data to apply color forming information to first toner image TA (a color forming information-applying process). First toner image TA applied with color forming information is transferred to intermediate transfer belt 20 (a first transfer process). Then, residual toner TA-1 remaining on first photoconductor 11A after transfer is removed (a first cleaning process).

On the other hand, in the second image-forming unit, after second photoconductor 11B is uniformly negatively charged with the black coloring toner, negatively charged second photoconductor 11B is exposed with image-forming data of, e.g., black (K), to form an electrostatic latent image on second photoconductor 11B, and then the latent image is developed with a second developer containing the negatively charged black coloring toner to form second toner image TB (a second toner image forming process). The second toner image TB is then transferred to intermediate transfer belt 20 (a second transfer process). After that, residual toner TB-1 remaining on second photoconductor 11B after transfer is removed (a second cleaning process).

Each toner image transferred to intermediate transfer belt 20 is transferred to recording medium S and fixed (a transfer process, a fixing process), before or after, or at the same time with, the above processes, color development reaction of the color forming control toner by heat is performed (a color development process), and further, the surface of recording medium S after fixation is irradiated with light to remove and bleach the background color (a photo-irradiation process). Thus, a color image is obtained.

In the image-forming apparatus in the first exemplary embodiment, since images other than a black image are formed with a color forming control toner in first image-forming unit 10A on one hand, and a black image is formed with a black coloring toner (a toner containing a black colorant) in second image-forming unit 10B on the other hand, the image density of the black image is high, and running costs can be reduced.

Further, since a full color image can be obtained with two image-forming units (two image carriers and two developing machines), the apparatus can be greatly miniaturized. In addition, it is not necessary to laminate toners with every color in the formation of a toner image, so that the unevenness of an image surface can be suppressed, the glossiness of an image surface can be made uniform, and it is also possible to obtain a silver salt-like image.

The constitution of the image-forming apparatus in the exemplary embodiment will be explained in line with each process in image-forming process.

### —First Image Forming Unit 10A—

### <First Toner Image-Forming Process>

In the first toner image-forming process, the entire surface of first photoconductor 11A is charged with first charger 12A in the first place. The surface of first photoconductor 11A is then exposed according to image data with first exposing apparatus 13A. Then, an electrostatic latent image is developed with a first developer containing a color forming control toner to form first toner image TA.

As first photoconductor 11A, any known photoconductors can be used, e.g., photoconductors having a drum-like conductive substrate (e.g., a metal cylinder such as aluminum) formed thereon an inorganic photosensitive layer such as Se, a-Si, etc., or an organic photosensitive layer of a single layer or multilayer are exemplified. In the case of a belt-like photoconductor, as the substrate, a transparent resin substrate such as PET, PC, etc., and a nickel seamless belt substrate can be used. The thickness is determined from design items such as the diameter and tensile force of the roll straining the belt-like photoconductor, and is in the range of from about 10 to 500 μm or so. Other layer structure and the like are the same as the case of the drum-like photoconductor.

Since the later-described exposure for color forming information application is performed at relatively high intensity as compared with the exposure for ordinary latent image formation (the quantity of energy necessary for color forming information application is about 1,000 times the exposure amount of a photoconductor used in ordinary electron photographic process (2 mJ/m²)), the damage to first photoconductor 11A is worried, but, for example, when the photosensitivity of a charge-generating layer of first photoconductor 11A is made 1/1,000 of conventional photosensitivity, the quantity of energy and photosensitivity are well-balanced, so that there occurs no problem.

Further, the surface of first photoconductor 11A may be provided with a function to prevent deterioration of first photoconductor 11A by the exposure for applying color forming information. Specifically, it is effective to provide, on the surface of the photosensitive layer, a surface layer capable of transmitting the exposure light for forming a latent image alone and reflecting the exposure light for applying color forming information (only transmitting the-exposure light for forming a latent image). As the surface layer, dichroic coat (reflection) and sharp cut filter having dispersed a light absorbing material (absorption) can be exemplified.

On the other hand, as first charger 12A, known methods of charging can be used. In the case of a contact system, a roll, a brush, a magnetic brush and a blade can be used, and in the case of a non-contact system, Corotron and Scorotron can be used. The methods of charging are not restricted thereto.

Of these methods, from the balance of charge compensation ability and the amount of generation of ozone, a contact type charger is preferably used. The contact charging method is charging by applying voltage to a conducting material being in contact with the surface of a photoconductor to charge the surface of the photoconductor. The shapes of conducting materials may be any of brush-like, blade-like, pin electrode-like and roll-like shapes, and a roll-like shape is preferred of these shapes. A roll-like material usually includes a resisting layer, an elastic layer supporting the resisting layer and a core material in order of from the outside. If necessary, a protective layer may be provided on the outside of the resisting layer.

As the method of charging first photoconductor 11A with a conducting material, voltage is applied to a conducting material, but applied voltage may be direct current voltage or superposition of direct current voltage and alternating current voltage. As the range of the voltage, in the case of charging by direct current alone, plus or minus of desired surface potential +500 V or so as the absolute value is preferred, and the value is in the range of from 700 to 1,500 V. When alternating current voltage is superposed, the direct current value is desired surface potential ±50 V or so, the voltage between peaks of alternating current (Vpp) is from 400 to 1,800 V, preferably from 800 to 1,600 V, the frequency of alternating current voltage is from 50 to 20,000 Hz, preferably from 100 to 5,000 Hz, and any of sine wave, square wave and triangular wave can be used. Charge potential may be set in the range of from 150 to 700 V as the absolute value of potential.

Further, as first exposing apparatus 13A, e.g., a laser scanning system, an LED image bar system, an analog exposure system, and an ion current control head can be used, and the surface of first photoconductor 11A can be exposed as shown by the arrow. Besides the above, novel exposing methods that will be developed hereafter can be used so long as the effect of the invention can be achieved.

As the wavelengths of light sources, the wavelengths in the region of the spectral sensitivity of first photoconductor 11A are used. As the wavelengths of semiconductor lasers, near infrared rays having oscillation wavelength in the vicinity of 780 nm have been mainly used heretofore, but lasers having oscillation wavelengths of the level of 600 nm, and lasers having oscillation wavelengths in the vicinity of from 400 to 450 nm as blue lasers can also be used. For color image formation, it is also possible to use surface emitting type laser light sources capable of multi-beam output.

The exposure of first photoconductor 11A with first exposing apparatus 13A is performed as logical sum of image-forming data of the above four colors, at the position where the later-described toner is developed in the case of reversal development, and at the position other than the position where the toner is developed in the case of ordinary development. The diameter of exposure spot is adjusted to be in range of from 40 to 80 82 m to make the resolution in the range of from 600 to 1,200 dpi. The exposure amount may be such that the potential after exposure is about from 5 to 30% of the charge potential, but when the development amount of the toner is changed with the gradation of image, exposure amount may be changed with the development amount with every exposure position.

As first developing apparatus 14A, known developing apparatus can be used. As developing methods, there are a two-component developing method using fine particles called a carrier for carrying a toner and a toner, a one-component developing method using a toner alone, and a method of using other constituents in these developing methods for the purpose of the improvements of development and other characteristics, and any of these methods can be used.

Further, according to developing methods, a developer may be in contact with first photoconductor 11A or may not be, or these developing methods may be combined. A hybrid developing method of combining the one-component developing method and two-component developing method can also be used. Besides the above, novel developing methods that will be developed hereafter can be used so long as the effect of the invention can be achieved.

As the color forming control toner contained in the developer, for example, a color developing part developable in Y (a Y color development part), a color developing part developable in M (a M color development part), and a color developing part developable in C (a C color development part) may be contained in one toner particle, or a Y color development part, a M color development part and a C color development part may be contained each in a different toner.

A toner development amount (the amount of a toner to be adhered to a photoconductor) varies according to an image formed, but the range of from 3.5 to 8.0 g/m² is preferred as a solid image, and more preferably from 4.0 to 6.0 g/m².

In formed first toner image TA, since the light for the application of color forming information, which is described later, is necessary to pervade over the irradiated area, the thickness of a toner layer is preferably not higher than a definite value. Specifically, for example, the toner layer is preferably three layers or less in a solid image, and more preferably two layers or less. Incidentally, the thickness of a toner layer is a value obtained by measuring the thickness of a toner layer formed on the surface of actual photoconductor 11, and dividing the measured value by number average particle size.

### <Color Forming Information Applying Process>

In the color forming information applying process, color forming information are applied to first toner image TA by light as the arrows with color forming information-applying apparatus 15A. Here, “application of color forming information by light” means to apply selectively one or more kinds of lights having specific wavelengths to a desired area of first toner image TA, or not to apply any light, for controlling the state of color development/non-color development, and the tone of developed color with every individual toner particle unit constituting first toner image TA. The position of the color forming information applying process may be after a transfer process, as described later.

As color forming information-applying apparatus 15A, any apparatus can be used so long as the apparatus can emit light of wavelength to color develop the color forming control toner particles to be color developed at that time in specific color with prescribed resolution and intensity. For example, LED image bar, laser ROS, and the like can be used. The diameter of light irradiation spot on toner image T irradiated is adjusted to be in the range of from 10 to 300 μm, and more preferably from 20 to 200 μm, to make the resolution of an image to be formed in the range of from 100 to 2,400 dpi.

The wavelength of light used in maintaining the state of color development or non-color development is determined by the design of the materials of toners used. For example, when a toner that develops color by irradiation with light of specific wavelength (a photo-color development type toner) is used, light having wavelength of 405 nm (referred to as λ_{A} light) to develop yellow (Y), light having wavelength of 535 nm (referred to as λ_{B} light) to develop magenta (M), and light having wavelength of 657 nm (referred to as λ_{C} light) to develop cyan (C), are applied to respective positions desired to color develop.

To develop second colors, the above lights are combined, i.e., a combination of λ_{A} light and λ_{B} light to develop red (R), a combination of λ_{A} light and λ_{C} light to develop green (G), and a combination of λ_{B} light and λ_{C} light to develop blue (B) are applied to respective positions desired to color develop. Further, to develop third color, black (K), a position desired to color develop is irradiated with λ_{A} light, λ_{B} light and λ_{C} light by superposition.

On the other hand, in the case of a toner for maintaining the non-color development state by irradiation with light of specific wavelength (a photo-non-color development type toner), for example, in the case not to develop yellow (Y), light of 405 nm (λ_{A} light), in the case not to develop magenta (M), light of 535 nm (λ_{B} light), and in the case not to develop cyan (C), light of 657 nm (λ_{C} light), are applied to respective positions desired to color develop. Accordingly, in the case to color develop Y, λ_{B} light and λ_{C} light, in the case to color develop M, λ_{A} light and λ_{C} light, and in the case to color develop C, λ_{A} light and λ_{B} light are applied to respective positions desired to color develop.

To develop second colors, the above lights are combined, i.e., λ_{C} light to develop red (R), λ_{B} light to develop green (G), and λ_{A} light to develop blue (B) are applied to respective positions desired to color develop. Further, to develop third color, black (K), a position desired to color develop is not subjected to exposure.

Light from color forming information-applying apparatus 15A can be used by known image modulation methods, such as pulse width modulation, intensity modulation and combination of these two methods, according to necessity. The exposure amount of light is preferably from about 0.05 to about 0.8 mJ/m², and more preferably from about 0.1 to about 0.6 mJ/m². With respect to this exposure amount, in particular, the necessary exposure amount is in relationship with the developed toner amount, for example, the exposure amount is preferably in the range of from about 0.2 to about 0.4 mJ/m² to the developed amount of toner (solid) of about 5.5 g/m².

When the exposure light at this time is a laser beam, regarding the incidence of a laser beam to a photoconductor, it is generally necessary to incline a laser beam by several degrees (from 4° to 13°) to prevent return light to a monitor (a photo-detector) in laser. However, in the case of the color forming information-applying exposure in the invention, since return light is absorbed with a toner and return light is very small, a laser beam can enter at any angle including 0°.

Further, in connection with the above, color forming information-applying apparatus 15A may be arranged with first exposing apparatus 13A to form a latent image in the same body of apparatus. By this arrangement, an exposing unit including optical systems can be partially coevoluted and simplified, and further miniaturization of the apparatus as a whole can be realized.

By what timing and by what position control the exposure for the application of color forming information is performed will be simply explained below.

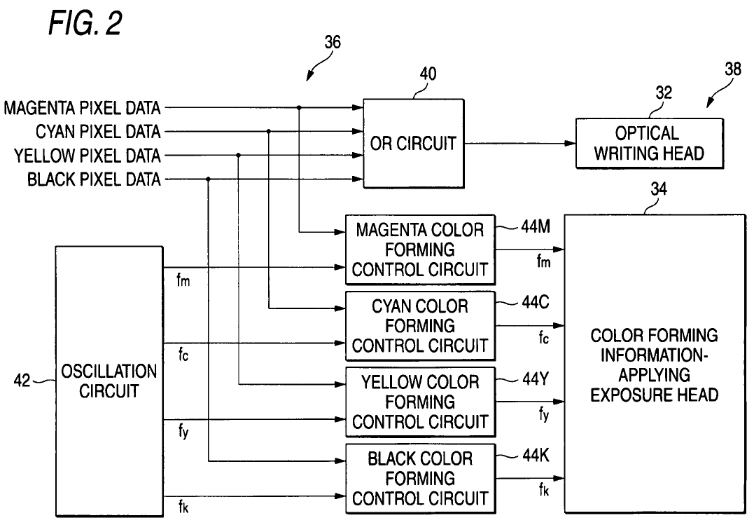

FIG. 2 is a specific circuit block diagram of printing controller. In FIG. 2, printer controller 36 includes OR circuit 40, oscillation circuit 42, magenta color forming control circuit 44M, cyan color forming control circuit 44C, yellow color forming control circuit 44Y, and black color forming control circuit 44K. On the other hand, exposure unit 38 includes optical writing head 32 and color forming information-applying exposure head 34.

Image data that are inputted RGB signals and converted to CMYK values by interface (I/F) not shown in the figure are further outputted to OR circuit 40 from interface (I/F) as magenta (M), cyan (C), yellow (Y) and black (K) pixel data. Here, OR circuit 40 computes logical sum of CMYK and outputs to optical writing head 32.

That is, the data of logical sum including all the pixel data of CMYK are outputted to optical writing head 32, and optical writing on first photoconductor 11A is performed as described before. Accordingly, an electrostatic latent image based on the logical sum data including all the pixel data of CMYK is formed on the periphery of first photoconductor 11A.

Further, the pixel data of CMYK are supplied to corresponding magenta color forming control circuit 44M to black color forming control circuit 44K, synchronized with oscillation signals fm, fc, fy and fk outputted from oscillation circuit 42, and outputted to color forming information-applying exposure head 34. That is, color forming information corresponding to each of magenta (M), cyan (C), yellow (Y) and black (K) are supplied to color forming information applying exposure head 34, and lights of specific wavelengths are emitted to maintain the state of color development or non-color development corresponding to first toner image TA formed on first photoconductor 11A. Accordingly, photo-curing reaction described later occurs in the toner accepted the emitted light and color forming information are applied.

For example, color developing signal fm outputted from magenta color forming control circuit 44M irradiates the color developing part in the toner with radiates λ_{B} light to makes the toner capable of magenta (M) color developable state. Color developing signal fc outputted from cyan color forming control circuit 44C irradiates the color developing part in the toner with λ_{C} light to makes the toner capable of cyan (C) color developable state. Yellow (Y) and black (K) are also the same, and color developing signals fy and fk outputted from yellow color forming control circuit 44Y and black color forming control circuit 44K irradiate the color developing parts in the toners with λ_{A} light or λ_{A} light, λ_{B} light and λ_{C} light to makes the toners capable of yellow (Y) and black (K) color developable states respectively.

As for color forming information-applying process, the mechanism of performing full color image formation has been described, but the color forming information-applying process may be a color forming information-applying process for forming a monocolor image of any of yellow, magenta and cyan. In this case, of yellow, magenta and cyan, the light of specific wavelength corresponding to desired color development alone is emitted from color forming information applying exposure head 34. Other conditions are the same as in the full color image formation.

Color forming information-applying process is performed after development and before transfer, but it is sufficient that color forming information-applying process is at least before fixing process, for example, color forming information-applying process may be performed after transfer process described later. However, when the exposure for the application of color forming information is performed after transfer process, considering the smoothness of the surface of recording medium S and the accuracy of color development position of a desired image, color forming information-applying process is preferably performed after development process and before transfer process for image quality.

However, at this stage, first toner image TA by a color forming control toner is not developed yet and has an original color tone as it is. For example, when first toner image TA is sensitized with a dyestuff, first toner image TA merely has the tone of the color of the dyestuff.

In the case where a photo-non-color development type toner is used, since a color forming information-applying unit is not necessary when only black-and-white image is formed, the image forming apparatus may be used as an image forming recording apparatus for forming only black-and-white images at first, and it is possible to add a color forming information-applying unit later when the demand for color images increases to extend the apparatus to a color image forming recording apparatus.

### <First Transfer Process>

In first transfer process, first toner images TA applied color forming information by first transfer apparatus 16A are collectively transferred to intermediate transfer belt 20.

Here, as first transfer apparatus 16A, known transfer apparatus can be used. For example, a roll, a brush, a blade, etc., can be used in the case of a contact system, and Corotron, Scorotron and Pincorotron can be used in the case of a non-contact system. It is also possible to perform transfer by pressure, or pressure and heat.

Transfer bias may be from 300 to 1,000 V (absolute value), and alternating current (Vpp: from 400 V to 4 kV, from 400 Hz to 3 kHz) may be superposed.

### <First Cleaning Process>

In first cleaning process, residual toner TA-1 remaining on first photoconductor 11A after transfer by first transfer apparatus 16A is removed with first cleaning apparatus 17A. As first cleaning apparatus 17A, known cleaning apparatus used in ordinary electron photographic process using conventional colorants, e.g., pigments, can be used, and a blade, a brush, etc., can be used.

### <Others>

In addition to these processes, known processes used in electron photographic process using conventional colorants, such as pigments, may be included. For example, by using a destaticizer on the upstream side of first charger 12A (e.g., an AC corona discharger) to remove the surface charge of first photoconductor 11A to substantially zero potential before the next image forming process.

### —Second Image Forming Unit 10B—

### <Second Toner Image Forming Process, Second Transfer Process, and Second Cleaning Process>

In second toner image forming process, second transfer process, and second cleaning process, second toner image TB by a black coloring toner can be formed and transferred to intermediate transfer belt 20 in substantially similarly to first toner image forming process, first transfer process, and first cleaning process.

### <Third Transfer Process>

In third transfer process, each toner image transferred to intermediate transfer belt 20 is transferred to the surface of recording medium S by third transfer apparatus 21.

As third transfer apparatus 21, known transfer apparatus can be used, and the details are the same as in first transfer apparatus 16A.

Known intermediate transfer belts can also be used as intermediate transfer belt 20. For example, synthetic resins, e.g., polyimide, polycarbonate, polyester, polypropylene, etc., and various rubbers containing an appropriate amount of an antistatic agent, e.g., carbon black, are used, and those having a volume resistivity of from 1×10⁹ to 1×10¹³ Ω·cm are used. Transfer belt is not restricted to intermediate transfer belt 20 and intermediate transfer drum can be used.

### <Fixing Process and Color Development Process>

In fixing process and color development process, second toner image TB and first toner image TA in a color developable state (or maintaining a non-color developable state) are fixed by recording medium S being heated with fixing apparatus 22, and at the same time, the color of the color forming control toner is formed. Known fixing apparatus can be used as fixing apparatus 22. For example, as the heating member and pressure member, a roll and a belt can be selected, and as heat source, a halogen lamp, IH, etc., can be used. The arrangement thereof is capable of coping with various paper passes, e.g., straight pass, rear C pass, front C pass, S pass, side C pass, etc.

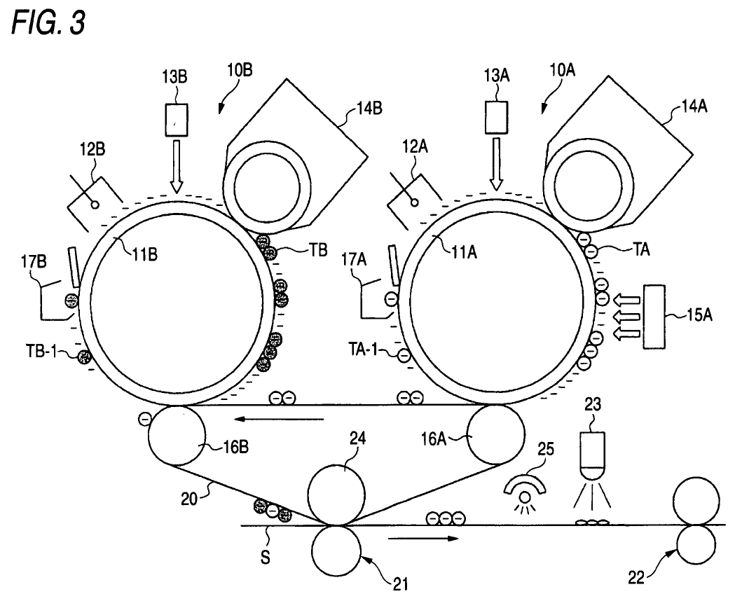

In the above exemplary embodiment, fixing apparatus 22 serves both as a color developing process and a fixing process, but a color developing process may be provided differently from a fixing process. The position for the arrangement of the color developing apparatus for performing color developing process is not especially restricted, and, for example, as shown in FIG. 3, color developing apparatus 25 and photo-irradiation apparatus 23 may be provided on the upstream side of fixing apparatus 22. By taking this arrangement, since the heating temperature for color development and the heating temperature for fixation of the toner on recording medium S can be separately controllable, degree of freedom of design of color developing materials and toner binder materials can be increased.

In this case, various methods are considered as to color development method according to the mechanism of color development of toner particles. As color forming apparatus 25 (a color forming unit), for example, a light emitting apparatus of emitting specific light can be used in a method of curing a color development relating material in a toner, or color development by photo-decomposition, or limiting color development with light of further different wavelengths, or pressure devices can be used in a method of color development by pressurizing to break capsulated color developing particles, or limiting color development.

However, these chemical reactions for color development are generally slow in reaction speed by migration and diffusion, so that it is necessary to give sufficient energy for diffusion in taking any of the methods, therefore, in this point, a method of accelerating reaction by heating may be said most excellent. Accordingly, to use fixing apparatus 22 serving both as a color developing process and a fixing process is preferred including space saving.

### <Photo-Irradiation Process>

In photo-irradiation process, an image obtained through fixing and color developing processes is irradiated with photo-irradiating apparatus 23. By the irradiation, since the reactive material remained in the color developing part of the color forming control toner controlled to a state of incapable of forming color can be decomposed or inactivated, the fluctuation of color balance after image formation can be controlled more surely, and removal and bleaching of the background color can be performed.

In the first exemplary embodiment, the photo-irradiation process is provided after the fixing process, but in the case of a fixing method without heat melting, e.g., in the case of a fixing method with pressure, the fixing process may be carried out after the photo-irradiation process.

Here, photo-irradiating apparatus 23 is not especially restricted so long as the color development of the toner can be prevented from progressing any more, and known lamps, e.g., a fluorescent lamp, LED, EL, etc., can be used. The wavelengths include three wavelengths for color developing the toners, the illuminance is preferably from 2,000 to 200,000 lux or so, and the exposure time is preferably in the range of from 0.5 to 60 sec.

Thus, a color image using the color forming control toner and the black coloring toner can be obtained.

### Second Exemplary Embodiment

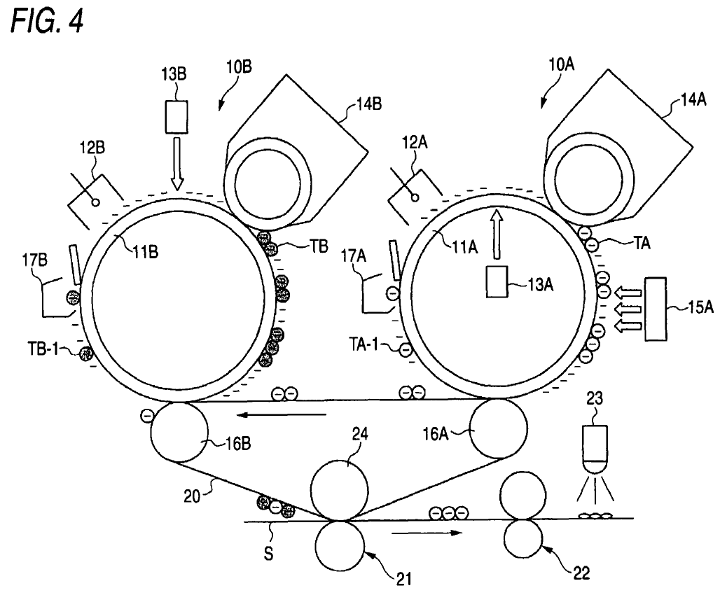

FIG. 4 is a schematic block diagram showing an image-forming apparatus related to a second exemplary embodiment.

As shown in FIG. 4, the image-forming apparatus related to the second exemplary embodiment is the same as the image forming apparatus in the first exemplary embodiment, except that first exposing apparatus 13A is arranged on the inside of first photoconductor 11A for performing exposure for forming a latent image from the rear side (inside) of first photoconductor 11A in first image-forming unit 10A, and the following constitutions are used as first photoconductor 11A.

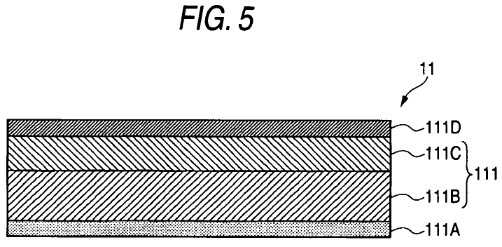

In the image forming apparatus related to the second exemplary embodiment, as shown in FIG. 5, first photoconductor 11A includes conductive support 111A, photosensitive layer 111, and surface layer 111D in lamination from the inner peripheral side toward the outer peripheral side in sequence.

Conductive support 111A has transparency to the light outgoing from first exposing apparatus 13A and incoming to conductive support 111A. “Transparency” shows the transmittance of outgoing light to incoming light (outgoing light/incoming light).

It is sufficient that the transmittance of conductive support 111A may be transmittance capable of forming an electrostatic latent image on the outer periphery of first photoconductor 11A by the light outgoing from first exposing apparatus 13A incoming from the inner peripheral side (i.e., conductive support 111A side) to the outer peripheral side of first photoconductor 11A. The transmittance of conductive support 111A is determined by the charge potential of first photoconductor 11A by first charger 12A and the exposure amount of first photoconductor 11A by first exposing apparatus 13A.

For example, under the conditions that exposure amount of light by first exposing apparatus 13A is a prescribed exposure amount and the transmittance of conductive support 111A to the light is 90%, supposing that it is possible to form an electrostatic latent image on the outer periphery of first photoconductor 11A, when the prescribed exposure amount is made triple, the transmittance of conductive support 111A to the light may be 30%.

Thus, it is sufficient that conductive support 111A has transparency to the light outgoing from first exposing apparatus 13A, and the transmittance may be sufficient if the transmittance is capable of forming an electrostatic latent image on the surface of first photoconductor 11A.

However, the transmittance of conductive support 111A to the light outgoing from first exposing apparatus 13A and incoming to conductive support 111A is preferably at least 70% or more, and more preferably 80% or more, from the viewpoint of restraining the reduction of electrostatic latent image contrast by light scattering in the inside of the conductive support and diffused reflection at the boundary of the photo-conductive support.

As the materials for constituting conductive support 111A having transparency to incoming light from first exposing apparatus 13A, glass, and plastic materials such as polycarbonate, polyethylene terephthalate, etc., are used, and for forming an electrode, a conductive layer is formed on the outer surface. Incidentally, the materials of conductive support 111A themselves may be subjected to electrically conductive treatment.

In providing the conductive layer on conductive support 11A, the conductive layer may be provided with a transparent electrode. As the transparent electrodes, electrodes obtained by coating a mixture of a binder resin and atomized metallic oxides, e.g., ITO, SnO₂, etc., and conductive polymers, e.g., polypyrrole can be used. The thickness of the transparent electrode is determined from the necessary conductivity and transparency, and it is preferably the range of from about 0.01 to 10 μm or so.

The thickness of conductive support 111A is determined from the necessary mechanical strength, and is preferably the range of from about 0.1 to 5 mm or so.

When first photoconductor 11A is belt-like, transparent resins, e.g., PET, PC, etc., having transparency as above can be used as conductive support 111A, and the thickness is determined from design items such as the diameter and tensile force of the roll straining the belt-like photoconductor, and is in the range of from about 10 to 500 μm or so. Other layer structure and the like are the same as the case of the drum-like photoconductor.

Photosensitive layer 111 is laminated on conductive support 11A.

As photosensitive layer 111, e.g., an inorganic photosensitive layer such as Se, a-Si, etc., or an organic photosensitive layer of a single layer or multilayer (charge generating layer 111B, charge transporting layer 111C, etc.) can be exemplified.

To still further generate scattering of light incoming from first exposing apparatus 13A, organic particles of metallic oxides and fluorine resins having a particle size of several ten nanometers to several micrometers may be dispersed in a photosensitive layer.

However, the light emitted from first exposing apparatus 13A should be sufficient to transmit transparent conductive support 111A and reach charge generating layer 111B.

The thickness of photosensitive layer 111 is determined from the insulating ability capable of withstanding charge potential, considering the above transparency and aging decrease in layer thickness, and it is in the range of from about 5 to 50 μm.

Surface layer 111D shows opacity to at least the light outgoing from the light source of color forming information-applying apparatus 15A and incoming to surface layer 111D, and it is desirable to also show opacity to the light outgoing from first exposing apparatus 13A and incoming to surface layer 111D.

Here, “opacity” means that the transmittance of outgoing light to incoming light to surface layer 111D (outgoing light/incoming light) is at least 20% or less.

As the transmittance of surface layer 111D, when first photoconductor 11A is irradiated with light from the outer periphery, transmittance capable of preventing the light more than the exposure energy that causes deterioration of photosensitive layer 111 (hereinafter referred to as deterioration exposure energy) from reaching photosensitive layer 111 through surface layer 111D is sufficient.

Therefore, the transmittance of surface layer 111D is determined by the value of deterioration exposure energy attributable to the material design of photosensitive layer 111, the exposure amount of first photoconductor 11A by the light outgoing from color forming information-applying apparatus 15A, the light absorbing efficiency of the toner to the light, and the like.

For example, supposing that exposure amount of first photoconductor 11A by first exposing apparatus 13A/exposure amount of first photoconductor 11A by color forming information-applying apparatus 15A is 1/1,000, deterioration exposure energy is about 10 times the exposure amount of first exposing apparatus 13A, and the absorption efficiency of the toner to the exposure light from color forming information-applying apparatus 15A is 90%, the transmittance to incoming light from first exposing apparatus 13A may be 10% or so (the rate of opacity is 90%).

Thus, as the transmittance of surface layer 111D, the transmittance capable of preventing the light more than deterioration exposure energy from reaching photosensitive layer 111 through surface layer 111D is sufficient, but at least to the light of wavelength to which photosensitive layer 111 has sensitivity, the transmittance is preferably less than 1% (the rate of opacity is 99% or more).

Thus, as the transmittance of surface layer 111D of first photoconductor 11A, by determining the transmittance capable of preventing the light more than deterioration exposure energy from reaching photosensitive layer 111 through surface layer 111D, photosensitive layer 111 of first photoconductor 11A can be restrained from deteriorating by light outgoing from the light source of color forming information-applying apparatus 15A.

Incidentally, surface layer 111D may also show opacity to light emitting from first exposing apparatus 13A and incoming to surface layer 111D to restrain irradiation with first exposing apparatus 13A formed outside.

The light transmittance to the incoming light of the light of first exposing apparatus 13A is preferably at least less than 10% (the rate of opacity is 90% or more) and the energy to be given to the toner is 0.01% or less of the exposure amount by the color forming information-applying unit.

Thus, as the transmittance of surface layer 111D of first photoconductor 11A, further by making the transmittance to light outgoing from the light source of first exposing apparatus 13A and incoming less than 10%, the light emitted from first exposing apparatus 13A does not reach the surface of an image carrier, as a result the effect of capable of avoiding color mixture can be obtained.

The materials of surface layer 111D having such transparency may be selected from any of organic materials, inorganic materials and metals, so long as first photoconductor 11A has surface resisting value of the degree of capable of carrying an electrostatic latent image and a toner image on surface layer 111D and having the transparency as above.

The surface resisting value is preferably from 10⁶ Ω to 10¹⁰ Ω.

The surface resisting value can be computed, for example, with circular electrode (HR probe of High Lester IP, outer diameter of cylindrical electrode C: φ16 mm, inner diameter of ring electrode D: φ30 mm, outer diameter: φ40 mm, manufactured by Mitsubishi Petrochemical Co., Ltd.) at 22° C., 55% RH by applying voltage of 100 V and finding a current value after 10 seconds.

For obtaining the above transparency, it is effective to use materials capable of absorbing or scattering light outgoing from the light source of color forming information-applying apparatus 15A and incoming to first photoconductor 11A, and light outgoing from the exposure light source of first exposing apparatus 13A and incoming to surface layer 111D of first photoconductor 11A.

Specifically, as the materials of surface layer 111D, polyurethane resin, acrylic resin, polycarbonate resin, or fluorine resin added with conductive powders (e.g., SnO₂/SbO₃) to adjust the surface resisting value can be used.

Also to the materials constituting surface layer 111D, carbon black etc. may be added to adjust transmittance to make a black layer.

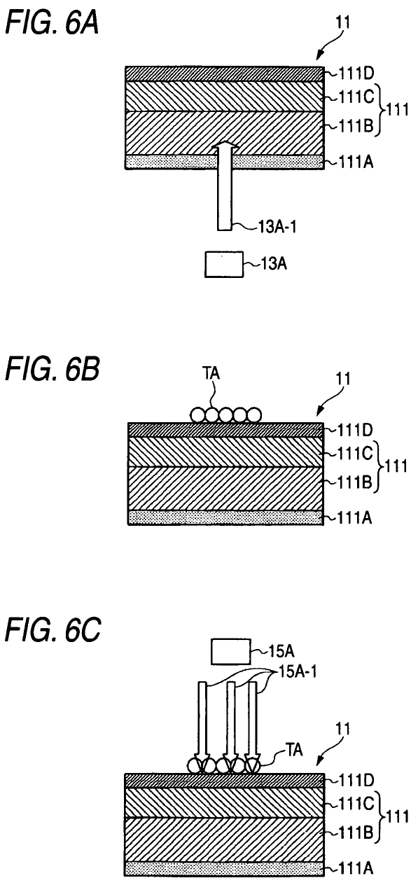

In the image-forming apparatus relating to the second exemplary embodiment, as shown in FIG. 6A, the exposure light source of first exposing apparatus 13A emits exposure light 13A-1 in the direction from the inner peripheral side toward the outer peripheral side of first photoconductor 11A. By exposure light 13A-1 emitted from first exposing apparatus 13A reaching photosensitive layer 111 through conductive support 111A of first photoconductor 11A, an electrostatic latent image is formed on the area corresponding to exposure position of the outer periphery of first photoconductor 11A (that is, on surface layer 111D).

By the rotation of first photoconductor 11A on the outer periphery of which the electrostatic latent image is formed, when the area where the electrostatic latent image is formed reaches the position opposing to first developing apparatus 14A, as shown by FIG. 6B, the electrostatic latent image is developed with first developing apparatus 14A, and first toner image TA corresponding to the electrostatic latent image is formed on first photoconductor 11A (specifically, on surface layer 111D of first photoconductor 11A).

Subsequently, by the rotation of first photoconductor 11A, when the area on first photoconductor 11A where first toner image TA is formed reaches the area capable of color forming information application with color forming information-applying apparatus 15A, as shown in FIG. 6C, color forming information-applying apparatus 15A exposes first toner image TA with exposure light 15A-1 of the wavelength corresponding to color component data of the image data from the outer peripheral side of first photoconductor 11A, i.e., from surface layer 111D side.

The toner image applied with color forming information by color forming information-applying apparatus 15A is transferred to intermediate transfer belt 20 by first transfer apparatus 16A.

Since other than the above are the same as in the first exemplary embodiment, explanation is omitted.

In the image-forming apparatus in the second exemplary embodiment as described, first photoconductor 11A includes conductive support 11A, photosensitive layer 111, and surface layer 111D in lamination from the inner peripheral side toward the outer peripheral side in sequence. Conductive support 111A is made of a material having transparency to the light outgoing from first exposing apparatus 13A and incoming to conductive support 11A, surface layer 111D is made of a material having opacity to the light outgoing from color forming information-applying apparatus 15A and incoming to surface layer 111D, the light source of first exposing apparatus 13A is provided on the inner periphery side -of first photoconductor 11A, and the light source of color forming information-applying apparatus 15A is provided on the outer periphery side of first photoconductor 11A.

Therefore, since exposure for applying color forming information is performed at relatively high intensity as compared with ordinary exposure for forming a latent image, the damage to first photoconductor 11A by color forming information application has been worried in a conventional image-forming apparatus, but in the image-forming apparatus in the exemplary embodiment, first photoconductor 11A includes outermost surface layer of non-light-transparent surface layer 111D, and the exposure of first photoconductor 11A with first exposing apparatus 13A by the exposure amount of a degree not relating to the deterioration of photosensitive layer 111 of first photoconductor 11A can be performed from the inner periphery side of first photoconductor 11A, and the exposure for the application of color forming information with color forming information-applying apparatus 15A necessitating the exposure amount of a degree possible of generating deterioration of photosensitive layer 111 of first photoconductor 11A can be performed from the outer periphery side of first photoconductor 11A.

Accordingly, by the exposure for the application of color forming information by the color forming control toner to first toner image TA carried on first photoconductor 11A, photosensitive layer 111 of first photoconductor 11A can be restrained from deteriorating, and image degradation in the image-forming apparatus can be inhibited. Thus, images can be formed repeatedly for a long period of time.

Incidentally, as described above, it is necessary that the exposure to apply color forming information be performed at relatively high intensity as compared with the exposure for ordinary latent image formation. Since the exposure for forming an ordinary latent image can be performed at relatively low intensity as compared with the exposure for applying color forming information, LED can be used as the exposure light source of first exposing apparatus 13A.

By using LED as the exposure light source of first exposing apparatus 13A, first exposing apparatus 13A can be miniaturized, and also first photoconductor 11A equipped with first exposing apparatus 13A on the inner periphery side can also be miniaturized. Accordingly, when LED is used as the exposure light source of first exposing apparatus 13A, the image-forming apparatus can be miniaturized.

Semiconductor laser may be used as the exposure light source of first exposing apparatus 13A and the light source of color forming information-applying apparatus 15A.

Thus, when semiconductor laser is used as both of the exposure light source first exposing apparatus 13A and the light source color forming information-applying apparatus 15A, the form of spot light arriving first photoconductor 11A in forming an electrostatic latent image on first photoconductor 11A by first exposing apparatus 13A, and the form of spot light arriving first photoconductor 11A in applying the color forming information to first toner image TA on first photoconductor 11A by color forming information-applying apparatus 15A can be made substantially the same. Therefore, it becomes possible to form an image of higher quality.

Incidentally, there are cases where the light for the application of color forming information is difficult to reach the lower layer part of the toner developed in multilayer on surface layer 111D of first photoconductor 11A, and sufficient color development cannot be obtained, as a result the color of the image after color development differs from desired color.

Therefore, surface layer 111D of first photoconductor 11A may be constructed to reflect the outgoing light from the light source of color forming information-applying apparatus 15A to the toner image again.

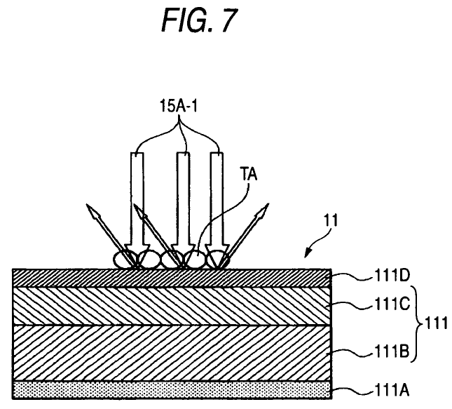

By this construction, as shown in FIG. 7, first toner image TA carried on surface layer 111D of first photoconductor 11A is exposed with exposure light 15A-1 for applying the color forming information, and exposure light 15A-1 reached surface layer 111D through first toner image TA is reflected and can expose first toner image TA again. Therefore, sufficient exposure for the application of color forming information is performed to first toner image TA and energy efficiency can be improved, further, sufficient color development of the toner can be obtained to thereby obtain desired tint in images.

Methods to construct surface layer 111D for reflecting the exposure light incoming from color forming information-applying apparatus 15A are not especially restricted so long as the methods can reflect the light. For example, there are a method of forming aluminum, silver, etc., to form a resistance value-adjusting layer, a method of using a layer formed by depositing dielectrics as surface layer 111D, and a method of lessening surface roughness to give a glossy surface.

The reflection of light by surface layer 111D may be irregular reflection in the point of capable of obtaining the same effect as described above.

The reflectance of the incoming light from color forming information-applying apparatus 15A by surface layer 111D is preferably 10% or higher, more preferably 50% or higher from the point of the reuse of reflected light to the toner, and still more preferably 90% or higher from the point of not transmitting the light to the photosensitive layer. When the reflectance is 10% or higher, the improvement of energy efficiency can be obtained, and when the reflectance is made 90% or higher by metal film coating on surface layer 111D, energy efficiency can be further increased and at the same time transmission of light to the photosensitive layer can be restrained the more.

### Third Exemplary Embodiment

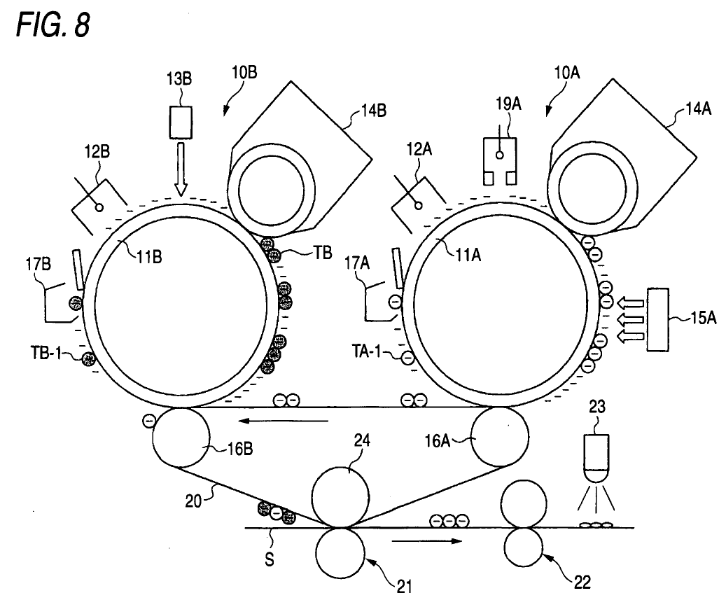

FIG. 8 is a schematic block diagram showing an image-forming apparatus related to a third exemplary embodiment.

The image-forming apparatus related to the third exemplary embodiment is an embodiment of applying dielectric drum 18A as a first image carrier in first image-forming unit 10A, and using ionic writing apparatus 19A to form a latent image by applying to charged dielectric drum 18A the ions of reversed polarity to charged dielectric drum 18A.

Dielectric drum 18A is a drum having a dielectric layer formed on the surface of a metal drum such as aluminum. The drum is not restricted to dielectric drum 18A, and may be a dielectric belt having dielectric as the substrate, or a dielectric belt having a dielectric layer formed on the surface of a substrate.

The examples of the materials constituting the dielectrics include, e.g., polyimide, fluorine resin, polyethylene, polypropylene, ionomer, polyvinyl alcohol, polyvinyl acetate, ethylene-vinyl acetate copolymer, poly-4-methylpentene-1, polymethyl methacrylate, polycarbonate, polystyrene, acrylonitrile-methyl acrylate copolymer, acrylonitrile-butadiene-styrene copolymer, polyethylene terephthalate, polyurethane elastomer, cellulose acetate, cellulose triacetate, cellulose nitrate, cellulose propionate, cellulose acetate butyrate, ethyl cellulose, regenerated cellulose, nylon 6, nylon 66, nylon 11, nylon 12, polysulfone, polyether sulfone, polyvinyl chloride, vinyl chloride-vinyl acetate copolymer, polyvinylidene chloride, vinylidene chloride, vinyl chloride copolymer, vinyl nitrile rubber alloy, polytetrafluoroethylene, polychlorotrifluoroethylene, polyvinyl fluoride, polyvinylidene fluoride, polyethylene-tetrafluoroethylene copolymer, etc.

On the other hand, in ionic writing apparatus 19A (ionic writing unit), charge of straight polarity is directly applied to negatively charged dielectric drum 18A by logical sum of image-forming data of four colors of, e.g., cyan (C), magenta (M), yellow (Y), and black (K) to form an electrostatic latent image. At this time, of the areas negatively charged, the negative charge of the area directly applied with charge of straight polarity is removed and a latent image is formed.

As ionic writing apparatus 19A, an ion flow control head of a so-called ion-flow system provided with a pair of control electrodes (control slits) equipped with an ion generator (e.g., a corona charger) and slits can be used. The ion flow control head controls the ions (minus ions in the exemplary embodiment) generated by corona discharge of the ion generator (e.g., a corona charger). Transit or non-transit to the slits of ion flow is controlled by the direction of electric field between a pair of control electrodes, and ions are selectively applied to uniformly formed toner to give charge.

Ionic writing apparatus 19A is not restricted to the above, and a minute structure electrode head equipped with a pair of indirect electrodes, and a control electrode to derive charge (electron and ion) generated by discharge between the indirect electrodes may be used. The minute structure electrode head generates charge (electron and ion) by discharge between a pair of indirect electrodes by ON/OFF control of 1 dot unit by an image signal, derives the charge with the control electrode and selectively gives the charge to the toner on the surface of an image carrier. Since the minute structure electrode head can generate a large amount of charge (electron and ion) by discharge between a pair of indirect electrodes, ion flow density is improved considerably and an image forming process is expedited.

Since other than the above are the same as in the first exemplary embodiment, explanation is omitted.

In the above-described image-forming apparatus relating to the exemplary embodiment, a first toner image by a color forming control toner is formed by so-called ionography. Good first toner image TA is formed in such an image-forming process, and excellent functions such as the effective improvement of image quality and repeating stabilization are exhibited. In addition, exposure to apply color forming information to first toner image TA with the color forming control toner is exposure with a large quantity of light, therefore, by using dielectric drum 18A as the image carrier for latent image formation, the deterioration of the image carrier by the exposure is prevented, and image can be formed for a long period of time repeatedly.

The color forming control toner for use in the image-forming apparatus relating to the exemplary embodiment is described below.

As described above, the color forming control toner is a toner controlled by the application of color forming information by light so as to be capable of maintaining the state of color development or non-color development. The meanings of “the application of color forming information by light” and “maintaining the state of color development or non-color development” are also the same as above.

As toners having the above function, there are various types of toners, for example, the toner disclosed in JP-A-2003-330228 is a toner containing particles containing plural microcapsules having a capsule wall that changes in transparency of a material by external stimulation, mixed and dispersed in the toner resin, and one side (dye precursors of various colors) of two kinds of reactive materials, which are mixed and react to each other to develop color, is contained in microcapsules, and the other side (a color former) is contained in the toner resin out of microcapsules in the particles.

The toner uses as the capsule walls a photoisomerization material that increases in transparency of a material when irradiated with light having specific wavelength, and two kinds of reactive materials present in and out of the capsules react to each other to develop color by utilizing the cis-trans transition when irradiated with light or ultrasonic wave is applied.

Accordingly, such a toner cannot contain many microcapsules in the toner, and sometimes the microcapsules localize and cannot accept sufficient light.

Therefore, in the exemplary embodiment, a color forming control toner having a first component and a second component present in a separate state from each other and develop color when reacted, and a photo-curable composition containing either the first component or the second component may be used (hereinafter sometimes referred to as “toner F”), and the photo-curable composition maintains a cured state or uncured state by the application of color forming information by light to thereby control the reaction for color development.

In the next place, the color development mechanism and simple constitution of toner F are explained below.

As described later, toner F has one or more continuous areas capable of color development in specific one color called a color developing part in a binder resin (or capable of maintaining a non-color development state) when color forming information by light is applied.

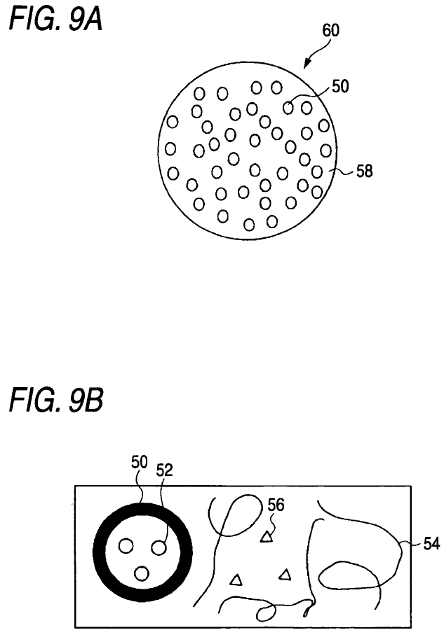

FIG. 9 is a view explaining the mechanism of color development of a toner. FIG. 9A is a cross-sectional view of one colored area, and FIG. 9B is an enlargement of the colored area.

As shown in FIG. 9A, color-developing part 60 includes color developable microcapsules 50 containing the coupler of each color, and composition 58 surrounding microcapsules 50, and as shown in FIG. 9B, composition 58 contains color former monomer 54 (the second component) having a polymerizable functional group to color develop by the approach to or contact with coupler 52 (the first component) contained in microcapsule 50, and photo-polymerization initiator 56.

In color developing part 60 that constitutes the toner particles, as coupler 52 encapsulated in color developable microcapsule 50, a triaryl leuco compound excellent in the brightness of developed color hue may be contained. As color former monomer 54 to color-develop the leuco compound (electron donating), an electron accepting compound is preferred. Phenolic compounds are generally used, and can be arbitrarily selected from color formers utilized in heat-sensitive and pressure-sensitive paper. By the acid-base reaction of electron donating coupler 52 and electron accepting color former monomer 54, the coupler develops color.

As photo-polymerization initiator 56, spectral sensitizing dyestuffs generating polymerizable radicals that are photosensitized by visible rays and become triggers to polymerize color former monomer 54 are used. For example, to the exposure of three primary colors of R, G. and B, a reaction accelerator of photo-polymerization initiator 56 is used so that color former monomer 54 can advance sufficient polymerization reaction. For example, by using ion complex including a spectral sensitizing dyestuff (a cation) that absorbs exposure light and a boron compound (an anion), the spectral sensitizing dyestuff is photo-excited by exposure and electrons transfer to the boron compound, thus polymerizable radicals are generated and polymerization is initiated.

By the combination of these materials, photosensitive color-developing part 60 can obtain color development recording sensitivity of from about 0.1 to about 0.2 mJ/m² or so.

By the existence or absence of photo-irradiation for color forming information application to color developing part 60, there is a case that color developing part 60 having polymerized color former compound and color former monomer 54 not polymerized is present. By the subsequent color development process such as heating, in color developing part 60 having color former monomer 54 not polymerized, color former monomer 54 migrates by heat and the like and passes through voids of the wall of color developable microcapsule 50 and diffuses into color developable microcapsule 50. Since color former monomer 54 diffused into color developable microcapsule 50 is acidic and coupler 52 is basic, as described above, coupler 52 is to be color-developed by acid-base reaction.

On the other hand, color former compound that generated polymerization reaction cannot diffuse and pass through voids of the wall of microcapsule 50 due to bulkiness by polymerization, so that cannot react with coupler 52 in color developable microcapsule 50 to develop color in the following color development process such as heating. Accordingly, color developable microcapsule 50 remains as colorless. That is, color developing part 60 irradiated with light of specific wavelength is to be present without being color developed.

After color development, by entirely exposing color developing part 60 again with a white light source at an appropriate stage, residual color former monomer 54 not polymerized is polymerized all, and stable image fixation is performed and, at the same time, the remaining spectral sensitizing dyestuff is decomposed to decolor the background color. The tone of the spectral sensitizing dyestuff as photo-polymerization initiator 56 corresponding to visible ray region remains to the last as background color, but photo-decoloration phenomenon of color/boron compound can be utilized in the decoloration of the spectral sensitizing dyestuff. That is, by transferring electrons from the photo-excited spectral sensitizing dyestuff to a boron compound, polymerizable radicals are generated, and the radicals cause polymerization of a monomer on one hand, but on the other hand, react with excited dyestuff radicals to cause color decomposition of a dyestuff, as a result the polymerizable radicals can decolor the dyestuff.

In toner F, color developing part 60 performing different color developments (e.g., color development in Y, M, and C) as above can be constructed as one microcapsule by making the state of each color former monomer 54 of not interfering with couplers other than the objective coupler 52 (the state being separated from each other). In toner F, space other than microcapsules including electron donating couplers is filled with electron accepting color former and photo-curable composition, and the color developing part having this constitution accepts light, therefore, the light-accepting efficiency per one toner particle is very high as compared with the toner disclosed in JP-A-2003-330228. Accordingly, as compared with other toners, the effect of back exposure can be sufficiently utilized with toner F.

Further, since the mechanism of the color forming information application is not reversible reaction, the time until color development by heating is not restricted, and low speed printing is possible, that is, the mechanism can cope with a wide speed range, in addition, the place of arrangement of the fixing apparatus for color development by heating can be freely selected.

The constitution of toner F will be further described in detail below.

Toner F contains, as the color developable materials, a first component and a second component that are present in the separate state from each other and develop color when reacted with each other. By making use of the reaction of two kinds of reactive components to develop color, the control of color development becomes easy. The first component and the second component may be colored in advance in the state before color development, but substantially colorless materials are preferred.

For making color forming control easier, two kinds of reactive components that develop colors when reacted with each other as color developing materials are used, but when these reactive components are present in the same matrix where the diffusion of materials is easy even in the state of not applied with color forming information by light, there are cases where color development progresses spontaneously during preservation or manufacturing of the toner.

Therefore, it is necessary that the reactive components be present with every kind in a different matrix where the diffusion of materials to mutual territory is difficult without the application of color forming information (separated from each other).

For the purpose of hindering the diffusion of materials in the state of free of the application of color forming information by light, and prevent spontaneous color development during preservation or manufacturing of the toner, it is effective to contain the first component of two kinds of reactive components in a first matrix, and the second component in a matrix other than the first matrix (a second matrix), and provide between the first matrix and the second matrix a partition wall having functions of hindering the diffusion of materials between both matrixes, and capable of diffusion of materials between both matrixes when external stimulations, e.g., heat, are given, according to the kind and strength of stimulation, and combination.

For including two kinds of reactive components in a toner by utilizing such a partition wall, microcapsules may be used.

In this case, of the two kinds of reactive components, for example, the first component may be contained in microcapsules and the second component may be contained outside of the microcapsules in toner F. In this case, the inside of the microcapsules corresponds to the first matrix and the outside of the microcapsules corresponds to the second matrix.

The microcapsules have the core and the shell covering the core, and microcapsules are not especially restricted so long as they have function of hindering the diffusion of materials in and out of the microcapsules unless external stimulations such as heat are given, and capable of diffusion of materials in and out of the microcapsules when external stimulations are given, according to the kind and strength of stimulation, and combination. Further, at least either of the above reactive components is contained in the core.

The microcapsules may be those capable of the diffusion of materials in and out of the microcapsules by the application of stimulations such as light irradiation and pressure, but heat-respondent microcapsules capable of the diffusion of materials in and out of the microcapsules by heat treatment (the permeability of materials of the shell increases) are preferred.

The diffusion of materials in and out of the microcapsules at the time when stimulations are applied may be irreversible from the points of the control of the reduction of color development density at the time of image formation, and the control of the fluctuation of color balance of the image allowed to stand under high temperature environment. Accordingly, the shell that constitutes a microcapsule may have a function that permeability of materials irreversibly increases by softening, decomposition, dissolution (compatibility with neighboring members), and deformation by the application of stimulations such as heat treatment and light irradiation.

In the next place, the constitution in the case where toner F contains microcapsules is described below.

Such a toner may contain a first component and a second component that develop color when reacted with each other, microcapsules, and a photo-curable composition containing the second component having dispersed therein. As such toners, the following three exemplary embodiments are exemplified.

That is, toner F may be any of an exemplary embodiment containing a first component and a second component that develop color when reacted with each other, a photo-curable composition, and microcapsules dispersed in the photo-curable composition, wherein the first component is contained in the microcapsules, and the second component is contained in the photo-curable composition (a first exemplary embodiment), an exemplary embodiment containing the first component and the second component that develop color when reacted with each other, and the microcapsules containing the photo-curable composition, wherein the first component is contained out of the microcapsules, and the second component is contained in the photo-curable composition (a second exemplary embodiment), and an exemplary embodiment containing the first component and the second component that develop color when reacted with each other, the microcapsules containing the first component, and other microcapsules containing the photo-curable composition having dispersed therein the second component (a third exemplary embodiment).

Of these three exemplary embodiments, the first exemplary embodiment is preferred for the stability of the application of color forming information by light, and the control of color development. In the following detailed explanation of toner, fundamentally the toner in the first exemplary embodiment is premised on the explanation, but the structures, materials and manufacturing methods of the toner in the first exemplary embodiment can be of course utilized in and appropriated for the toners in the second and third exemplary embodiments.

Toner F using the heat-respondent microcapsules and the photo-curable composition in combination may be any of the following two types.
(1) A toner of the type that even when the toner is heat-treated in the state that the photo-curable composition is uncured, the material diffusion of the second component contained in the uncured photo-curable composition is controlled, and when heat-treated after the photo-curable composition has been cured by irradiated with light for color forming information application, the material diffusion of the second component contained in the photo-curable composition after curing is accelerated (hereinafter sometimes referred to as “a photo-color development type toner”);
(2) A toner of the type that when the toner is heat-treated in the state that the photo-curable composition is uncured (the state that the second component is not polymerized), the material diffusion of the second component contained in the uncured photo-curable composition is accelerated, and when heat-treated after the photo-curable composition has been cured by irradiated with light for color forming information application (after the second component has been polymerized), the material diffusion of the second component contained in the photo-curable composition after curing is controlled (hereinafter sometimes referred to as “a photo-non-color development type toner”).

The difference between the photo-color development type toner and the photo-non-color development type toner is in the materials constituting the photo-curable compositions. In the photo-color development type toner, the second component (not having photo-polymerizability) and a photo-polymerizable compound are at least contained in the photo-curable composition, while in the photo-non-color development type toner, the second component having a photo-polyerizable group in the molecule is at least contained in the photo-curable composition.

Incidentally, a photo-polymerization initiator may be contained in the photo-curable compositions for use in the photo-color development type toner and the photo-non-color development type toner, and if necessary, various other materials may be contained.

The photo-polymerizable compound and the second component for use in the photo-color development type toner are such materials that interaction works between the photo-polymerizable compound and the second component in the state of the photo-curable composition being uncured, and the material diffusion of the second component in the photo-curable composition is controlled, the interaction between both compounds decreases after the photo-curable composition has been cured (polymerization of the photo-polymerizable compound) by irradiated with light for color forming information application, and the diffusion of the second component in the photo-curable composition becomes easy.

Accordingly, in the photo-color development type toner, by previously irradiating the photo-curable composition with light of the wavelength for applying color forming information for curing before heat treatment (color development process), the material diffusion of the second component contained in the photo-curable composition becomes easy. Accordingly, when the toner is subjected to heat treatment, by the dissolution of the shell of the microcapsule, the reaction (color development reaction) of the first component in the microcapsule and the second component in the photo-curable composition occurs.

Contrary to this, even when the toner is subjected to heat treatment as it is without irradiating the photo-curable composition with light of the wavelength for applying color forming information for curing, the second component is trapped with the photo-polymerizable compound and is not brought into contact with the first component in the microcapsule, accordingly the reaction (color development reaction) of the first component and the second component does not occur.

As described above, in the photo-color development type toner, by performing the combination of the presence or absence of the irradiation of the photo-curable composition with light of the wavelength for applying color forming information for curing and heat treatment, the reaction (color development reaction) of the first component and the second component can be controlled, as a result, the color development of the toner can be controlled.

In the photo-non-color development type toner, since the second component itself has photo-polymerizability, even when the toner is irradiated with light for applying color forming information, if the wavelength of the light is not the wavelength for curing the photo-curable composition, the state of the material diffusion of the second component contained in the photo-curable composition being easy can be maintained, therefore, when the toner is subjected to heat treatment in this state, by the dissolution of the shell of the microcapsule, the reaction (color development reaction) of the first component in the microcapsule and the second component in the photo-curable composition occurs.

Contrary to this, when the photo-curable composition is irradiated with light of the wavelength for applying color forming information for curing before heat treatment, since the second component contained in the photo-curable composition polymerizes with each other, the material diffusion of the second component contained in the photo-curable composition becomes difficult. Accordingly, even when the toner is subjected to heat treatment, the second component cannot be brought into contact with the first component in the microcapsule, so that the reaction (color development reaction) of the first component and the second component does not occur.

As described above, in the photo-non-color development type toner, by performing the combination of the presence or absence of the irradiation of the photo-curable composition with light of the wavelength for applying color forming information for curing and heat treatment, the reaction (color development reaction) of the first component and the second component can be controlled, as a result, the color development of the toner can be controlled.

In the next place, regarding the structure of toner F, the case where the toner contains the photo-curable composition, and microcapsules dispersed in the photo-curable composition will be described in more detail.

In this case, the toner may contain one kind alone of a color developing part containing the photo-curable composition and microcapsules dispersed in the photo-curable composition, or may contain two or more color developing parts. Here, “color developing part” means continuous area capable of color development in specific one color when external stimulation is applied.

Incidentally, when two or more color developing parts are contained in the toner, a color developing part capable of color development in the same color may be contained in the toner one kind alone, but it is preferred that two or more color developing parts capable of color development in different colors from each other are contained in the toner. The reason is that the color capable of color development of one toner particle is limited to one kind in the former, but two or more kinds are capable of color development in the latter.

For example, as two or more color developing parts capable of color development in different colors from each other, a combination containing a yellow color developing part capable of color development in yellow, a magenta color developing part capable of color development in magenta, and a cyan color developing part capable of color development in cyan is exemplified.

In this case, when any one kind of color developing part alone is color developed by the application of external stimulation, toner F can be color developed in any color of yellow, magenta and cyan, and when any two kinds of color developing parts are color developed, toner F can be color developed in colors combining the colors developed by these two kinds of color developing parts. Thus, one toner particle can express a variety of colors.

The control of colors to be color developed in the case where two or more color developing parts capable of color development in different colors from each other are contained in toner F can be realized by varying the kinds and combinations of the first component and the second component contained in color developing parts of each kind, and varying the wavelengths of lights used for curing the photo-curable composition contained in color developing parts of each kind.

That is, in this case, since necessary wavelengths of light for curing the photo-curable composition contained in the color developing part are different with every kind of color developing part, the plural kinds of color forming information applying lights different in wavelengths according to the kinds of the color developing parts may be used. Incidentally, to vary the wavelength of light necessary for curing the photo-curable composition contained in color developing part of each kind, a photo-polymerization initiator sensitive to light of different wavelength of the color developing part may be contained in the photo-curable composition with every kind.

For example, in the case where three kinds of color developing parts capable of color development in yellow, magenta and cyan are contained in toner F, when a material that is cured by responding to any of the wavelengths of 405 nm, 532 nm and 657 nm is used as the photo-curable composition contained in each kind of color developing part, toner F can be color developed in desired color by properly using these three color forming information-applying lights (lights having specific wavelengths) different in wavelength.

The wavelengths of light for applying color forming information can be selected from the wavelengths in visible region, but the wavelengths may be selected from the wavelengths in ultraviolet region.

Toner F may contain matrixes containing as the main component binder resins similar to those used in conventional toners using colorants, such as pigments. In this case, each of the above two or more color developing parts may be dispersed in the matrixes as particulate capsules (hereinafter capsular one color developing part is sometimes referred to as “photosensitive/heat-sensitive capsule). Further, a releaser and various additives may be contained in the matrixes similarly to conventional toners using colorants, such as pigments.

A Photosensitive/heat-sensitive capsule has the core containing microcapsules and photo-curable composition, and the shell covering the core, and the shell is not especially restricted so long as the microcapsules and photo-curable composition contained in the photosensitive/heat-sensitive capsule are stably maintained so as not to leak out of the photosensitive/heat-sensitive capsule during the later-described manufacturing process and preservation of the toner.

However, in the later-described manufacturing process of the toner, to prevent the second component from permeating through the shell and going into the matrix out of the photosensitive/heat-sensitive capsule, or to prevent the second component in the photosensitive/heat-sensitive capsule capable of color developing in different color from permeating through the shell and coming into the capsule, nonaqueous materials such as a binder resin of a nonaqueous resin and a releaser may be contained as the main component.

Materials for use in toner F and materials and methods for use in manufacturing each material of the toners are described in detail below.

In this case, the first component, the second component, the microcapsule containing the first component, and the photo-curable composition containing the second component are at least used in toner F, and a photo-polymerization initiator may be contained in the photo-curable composition. Various auxiliaries may be used. The first component may be present in the microcapsule (the core) in a solid state, or may be present together with a solvent.

In the photo-non-color development type toner, an electron donating leuco dye, a diazonium salt compound, etc., are used as the first component, and an electron accepting compound having a photo-polymerizable group, a coupler compound having a photo-polymerizable group, etc., are used as the second component. Further, in the photo-color development type toner, an electron donating leuco dye is used as the first component, an electron accepting compound (sometimes called “electron accepting color former” or “color former”) is used as the second component, and as the photo-polymerizable compound, a polymerizable compound having an ethylenic unsaturated bond is used.

In addition to the above-enumerated materials, various materials similar to the materials used in toners using conventional colorants, e.g., binder resins, releasers, inner additives, outer additives, etc., can further be arbitrarily used, if necessary. Each material is described in detail below.

### —First Component and Second Component—

As the combinations of the first component and the second component, the following (a) to (r) are exemplified (in the following examples, the former is the first component and the latter is the second component).
(a) A combination of an electron-donating leuco dye and an electron accepting compound,
(b) A combination of a diazonium salt compound and a coupling component (hereinafter arbitrarily referred to as “a coupler compound”),
(c) A combination of an organic acid metal salt, e.g., silver behenate, silver stearate, etc., and a reducing agent, e.g., protocatechinic acid, spiroindane, hydroquinone, etc.,
(d) A combination of a long chain fatty acid iron salt, e.g., ferric stearate, ferric myristate, etc., and phenols, e.g., tannic acid, gallic acid, ammonium salicylate, etc.,
(e) A combination of an organic acid heavy metal salt of nickel, cobalt, lead, copper, iron, mercury, or silver salt with acetic acid, stearic acid, palmitic acid, etc., and sulfide of alkali metal or alkaline earth metal, e.g., calcium sulfide, strontium sulfide, potassium sulfide, or a combination of the above organic acid heavy metal salt and organic chelating agent, e.g., s-diphenylcarbazide, diphenylcarbazone, etc.,
(f) A combination of a heavy metal sulfate, e.g., silver sulfate, lead sulfate, mercury sulfate, or sodium sulfate, and a sulfur compound, e.g., sodium tetrathionate, sodium thiosulfate, thiourea, etc.,
(g) A combination of aliphatic ferric salt, e.g., ferric stearate, and an aromatic polyhydroxyl compound, e.g., 3,4-hydroxytetraphenylmethane, etc.,
(h) A combination of organic acid metal salt, e.g., silver oxalate, mercury oxalate, etc., and organic polyhydroxyl compound, e.g., polyhydroxy alcohol, glycerol, glycol, etc.,
(i) A combination of fatty acid ferric salt, e.g., ferric pelargonate, ferric laurate, etc., and a derivative of thiocesylcarbamide, isothiocesylcarbamide, etc.,
(j) A combination of organic acid lead salt, e.g., lead caproate, lead pelargonate, lead behenate, etc., and thiourea derivative, e.g., ethylenethiourea, N-dodecylthiourea, etc.,
(k) A combination of higher fatty acid heavy metal salt, e.g., ferric stearate, copper stearate, etc., and zinc dialkyl-dithiocarbamate,
(l) A combination that forms an oxazine dye, e.g., a combination of resorcin and nitroso compound,
(m) A combination of a formazan compound and at least one of a reducing agent and a metal salt,
(n) A combination of a protected dyestuff (or a leuco dyestuff) precursor and a deprotective agent,
(o) A combination of an oxidation type coupler and an oxidant,
(p) A combination of phthalonitriles and diiminoisoindolines (a combination of forming phthalocyanine),
(q) A combination of isocyanates and diiminoisoindolines (a combination of forming a coloring pigment), and
(r) A combination of a pigment precursor and acid or base (a combination of forming a pigment).

The enumerated first components may be substantially colorless electron donating leuco dyes or diazonium salt compounds.

As the electron donating leuco dyes, conventionally known compounds can be used, and every compound capable of reacting with the second components above to develop colors can be used. Specifically, various kinds of compounds, e.g., phthalide compounds, fluoran compounds, phenothiazine compounds, indolylphthalide compounds, leucoauramine compounds, rhodamine lactam compounds, triphenylmethane compounds, triazene compounds, spiropyran compounds, pyridine compounds, pyrazine compounds, fluorene compounds, etc., can be exemplified.

The second components in the case of the photo-non-color development type toner are substantially colorless compounds having a photo-polymerizable group and a site capable of color development by reacting with the first component in the same molecule, and every compound capable of color development by reacting with the first component, e.g., an electron accepting compound having a photo-polymerizable group or a coupler compound having a photo-polymerizable group, and having functions of polymerizing and curing by reacting with light can be used.

As the electron accepting compound having a photo-polymerizable group, i.e., a compound having an electron accepting group and a photo-polymerizable group in the same molecule, every compound having a photo-polymerizable group, capable of reacting with an electron donating neuco dye that is one of the first components to thereby develop color, and polymerizing and curing by light can be used.

As the electron accepting color former, the second component, in the case of the photo-color development type toner, phenol derivatives, sulfur-containing phenol derivatives, organic carboxylic acid derivatives (e.g., salicylic acid, stearic acid, resorcinolic acid, etc.), metal salts thereof, sulfonic acid derivatives, urea or thiourea derivatives, acid clay, bentonite, novolak resins, metal-treated novolak resins, metal complexes, etc., are exemplified.

Further, in the photo-color development type toner, polymerizable compounds having an ethylenic unsaturated bond are used as the photo-polymerizable compound, and these are polymerizable compounds having at least one ethylenic unsaturated double bond in the molecule of acrylic acid, salts thereof, acrylic esters, acrylamides, etc.

Subsequently, the photo-polymerization initiator is described below. The photo-polymerization initiator can generate radicals by the irradiation with light applying color forming information to thereby cause polymerization reaction in the photo-curable composition, and accelerate the reaction. The photo-curable composition is cured by the polymerization reaction.

The photo-polymerization initiator can be arbitrarily selected from known compounds, and the photo-polymerization initiator may contain a spectral sensitizing compound having maximum absorption wavelength in the range of from 300 to 1,000 nm, and a compound that interacts with the spectral sensitizing compound.

However, when the compound that interacts with the spectral sensitizing compound is a compound having both structures of a dyestuff site having maximum absorption wavelength in the range of from 300 to 1,000 nm, and a borate site in the structure, the spectral sensitizing dyestuff may not be used.

As the compound that interacts with the spectral sensitizing compound, one or two or more compounds can be arbitrarily selected and used from known compounds capable of initiating photo-polymerization reaction with the photo-polymerizable group in the second component.

By the coexistence of the compound that interacts with the spectral sensitizing compound with the spectral sensitizing compound, the compound reacts sensitively to the irradiation light of the spectral absorption wavelength region and generates radicals with high efficiency, thus sensitivity can be increased, and generation of radicals can be controlled with arbitrary light sources of from ultraviolet to infrared region.

As “the compound that interacts with the spectral sensitizing compound”, organic borate compounds, benzoin ethers, S-triazine derivatives having a trihalogen-substituted methyl group, organic peroxides, and azinium salt compounds are preferred, and organic borate compounds are more preferred. By using “the compound that interacts with the spectral sensitizing compound” and the spectral sensitizing compound in combination, radicals can be generated at exposed area locally and effectively, thus higher sensitization can be achieved.

For the purpose of accelerating polymerization reaction, an oxygen scavenger, a reducing agent such as a chain transfer agent of active hydrogen donor, and other compounds that accelerates polymerization as like chain transfer can be added to the photo-curable composition as auxiliaries.

As the oxygen scavengers, phosphine, phosphonate, phosphite, and other compounds easily oxidized by monosilver salt or oxygen can be exemplified. Specifically, N-phenylglycine, trimethylbarbituric acid, N,N-dimethyl-2,6-diisopropylaniline, and N,N,N-2,4,6-pentamethylanilinic acid are exemplified. Further, thiols, thioketones, trihalomethyl compounds, lophine dimer compounds, iodonium salts, sulfonium salts, azinium salts, organic peroxides, azides, etc., can also be useful as polymerization accelerators.

In toner F, the first component such as an electron donating leuco dye and a diazonium salt is used by encapsulation in microcapsules.

As the microencapsulating method, conventionally known methods can be used. For example, a method utilizing coacervation of a hydrophilic wall-forming material as disclosed in U.S. Pat. Nos. 2,800,457 and 2,800,458, an interfacial polymerization method as disclosed in U.S. Pat. No. 3,287,154, British Patent 990,443, JP-B-38-19574 (the term “JP-B” as used herein refers to an “examined Japanese patent publication”), JP-B-42-446, and JP-B-42-771, a method of polymer precipitation as disclosed in U.S. Pat. Nos. 3,418,250 and 3,660,304, a method of using an isocyanate polyol wall material as disclosed in U.S. Pat. No. 3,796,669, a method of using an isocyanate wall material as disclosed in U.S. Pat. No. 3,914,511, a method of using wall-forming material of urea-formaldehyde, urea-formaldehyde-resorcinol as disclosed in U.S. Pat. Nos. 4,001,140, 4,087,376, and 4,089,802, a method of using wall-forming material of a melamine-formaldehyde resin, hydroxypropyl cellulose, etc., as disclosed in U.S. Pat. No. 4,025,455, an in situ method by polymerization of a monomer as disclosed in JP-B-36-9168 and JP-A-51-9079, an electrolytic dispersion cooling method as disclosed in British Patents 952,807 and 965,074, a spray drying method as disclosed in U.S. Pat. No. 3,111,407 and British Patent 930,422, and methods as disclosed in JP-B-7-73069, JP-A-4-101885 and JP-A-9-263057 are exemplified.

The usable material of microcapsule wall is added to at least one of inside of oil droplets and outside of oil droplets. As the materials of microcapsule wall, polyurethane, polyurea, polyamide, polyester, polycarbonate, urea-formaldehyde resin, melamine resin, polystyrene, styrene-methacrylate copolymer, styrene-acrylate copolymer, etc., are exemplified. Of these materials, polyurethane, polyurea, polyamide, polyester, and polycarbonate are preferred, and polyurethane and polyurea are more preferred. These polymer materials can also be used in combination of two or more.

The volume average particle size of microcapsules is preferably adjusted in the range of from 0.1 to 3.0 μm, and more preferably from 0.3 to 1.0 μm.

A binder may be contained in the photosensitive and heat-sensitive capsules, and this is the same as in toners having one color developing part.

As the binders, the same binders as used in emulsion dispersion of the photo-curable composition, water-soluble polymers used in capsulation of the first reactive material, in addition, polymers soluble in a solvent, such as acrylic resin, e.g., polystyrene, polyvinyl formal, polyvinyl butyral, polymethyl acrylate, polybutyl acrylate, polymethyl methacrylate, polybutyl methacrylate, and copolymers of these resins, phenol resin, styrene-butadiene resin, ethyl cellulose, epoxy resin, urethane resin, and polymer latexes of these resins can also be used. Among them, gelatin and polyvinyl alcohol are preferred. The later-described binder resins may also be used as the binders.

Binder resins used in conventional toners may be used in toner F. For example, in toners having the structure of photosensitive/heat-sensitive capsules dispersed in the matrix, binder resins can be used as the materials of the main component of the matrix and shells of photosensitive/heat-sensitive capsules, but not restricted thereto.

Binder resins are not especially restricted, and known crystalline and amorphous resin materials can be used. In particular, for applying low temperature fixing ability, crystalline polyester resins having a sharp melt property may be used. As the amorphous polymers (amorphous resins), known resin materials such as styrene-acrylic resins and polyester resins can be used. Amorphous polyester resins are especially preferred.

Toner F may contain other components besides the above enumerated ones. Other components are not especially restricted and can be selected arbitrarily according to purpose, for example, various additives used in conventional toners, such as a releaser, inorganic particles, organic particles, an antistatic controller, etc., are exemplified.

The manufacturing method of toner F is described in brief.

Toner F may be manufactured with known wet manufacturing methods, e.g., a coagulation coalescence method. A wet manufacturing method is preferred for the manufacture of the toner containing the first component and the second component that develop color when reacted to each other, the photo-curable composition, the microcapsules dispersed in the photo-curable composition, wherein the first component is contained in the microcapsules and the second component is contained in the photo-curable composition.

The microcapsules for use in the toner having the above structure are preferably heat-respondent microcapsules, but the microcapsules may be respondent to other stimulations, e.g., light, etc.

Toner F can be manufactured according to known wet methods, and a coagulation coalescence method of these methods can restrain maximum manufacturing temperature low, and can manufacture toners having various structure easily.

As compared with toners containing conventional pigments and binder resins as the main components, since the toner having the above structure contains in large proportion of the photo-curable composition containing a low molecular component as the main component, the strength of particles obtained in granulation process is liable to be insufficient, but high shear force is not necessary in a coagulation coalescence method, accordingly a coagulation coalescence method is suitable in this point, also.

A coagulation coalescence method generally includes a coagulation process of forming coagulated particles, after preparing the dispersions of various materials constituting the toner, in a raw material dispersion obtained by mixing two or more of the dispersions, and a fusion process of fusing the coagulated particles formed in the raw material dispersion, and if necessary, an adhering process to adhere the component to form a covering layer on the surfaces of the coagulated particles (a covering layer-forming process) is carried out between the coagulation process and the fusion process.

Also in the manufacturing method of toner F, although the kinds and combinations of various dispersions for use as the raw material are different, besides the coagulation process and the fusion process, an adhering process can be arbitrarily combined according to necessity to manufacture the toner.

For example, in the case of toners having the structure of photosensitive/heat-sensitive capsule dispersion in the resin, one or more photosensitive/heat-sensitive capsule dispersions capable of developing colors different from each other are prepared through (a1) a first coagulation process of forming first coagulated particles in a raw material dispersion containing a microcapsule dispersion having dispersed microcapsules containing the first component, and a photo-curable composition dispersion having dispersed the photo-curable composition containing the second component, (b1) an adhering process of adding a first resin particle dispersion having dispersed resin particles to the raw material dispersion in which the first coagulated particles are formed, and adhering the resin particles on the surfaces of the coagulated particles, and (c1) a first fusion process of fusing the raw material dispersion containing the coagulated particles having adhered the resin particles on the surfaces by heating, to obtain first fused particles (photosensitive/ heat-sensitive capsules).

Subsequently, a toner having photosensitive/heat-sensitive capsule dispersion structure can be obtained through (d1) a second coagulation process of forming second coagulated particles in a mixed solution mixing the one or more photosensitive/heat-sensitive capsule dispersions and a second resin particle dispersion having dispersed resin particles, and (e1) a second fusion process of heating the mixed solution containing the second coagulated particles to obtain second fused particles.

Further, the kinds of photosensitive/heat-sensitive capsule dispersion used in the second coagulation process are preferably two or more. The obtained photosensitive/heat-sensitive capsules through processes (a1) to (c1) may be used as they are as a toner (that is, a toner containing only one color developing part alone).

Further, when a toner containing only one color developing part alone is manufactured, in place of the above adhering process, a first adhering process by adding a releaser dispersion having dispersed a releaser to the raw material solution in which the first coagulated particles are formed, and adhering the releaser on the surface of the coagulated particles, and a second adhering process of adding the first resin particle dispersion to the raw material solution after the first adhering process, and adhering the resin particles on the surfaces of the coagulated particles having adhered the releaser on the surfaces thereof, may be performed.

The volume average particle size of toner F usable in the invention is not especially restricted and arbitrarily selected according to the structure of the toner and the kinds and number of the color developing parts contained in the toner.

However, when the number of the color developing parts capable of developing colors different from each other contained in the toner is from two to four or so (for example, the case where the toner contains three kinds of color developing parts capable of developing colors of yellow, cyan and magenta), the volume average particle size corresponding to each toner is preferably in the following range.

That is, for example, when the structure of the toner is photosensitive/heat-sensitive capsule (color developing part) dispersion structure, the volume average particle size of the toner is preferably from 5 to 40 μm, and more preferably from 10 to 20 μm. The volume average particle size of the photosensitive/heat-sensitive capsule contained in the toner of photosensitive/heat-sensitive capsule dispersion structure having such a particle size is preferably from 1 to 5 μm, and more preferably from 1 to 3 μm.

When the volume average particle size of the toner is less than 5 μm, there are cases that color reproducibility deteriorates or image density lowers, since the amount of the color developing component contained in the toner decreases. Further, when the volume average particle size exceeds 40 μm, there are cases that the unevenness of the image surface is too large and unevenness of glossiness of the image surface occurs, and image quality lowers.

Incidentally, a photosensitive/heat-sensitive capsule dispersion structure type toner having dispersed inside the plural photosensitive/heat-sensitive capsules is liable to be large in the particle size as compared with small size toners (the volume average particle size is 5 to 10 Em or so) using conventional colorants, but the resolution of an image is determined by the particle size of the photosensitive/heat-sensitive capsules not by the particle size of the toner, therefore, higher precise images can be obtained. Further, the photosensitive/heat-sensitive capsule dispersion structure type toner is also excellent in fine particle flow, sufficient fluidity can be ensured with a little amount of outer additives, at the same time, developability and cleaning property can also be improved.

On the other hand, in the case of a toner having only one color developing part alone, making smaller particle size is easier as compared with the above case, and the volume average particle size is preferably from 3 to 8 μm, and more preferably from 4 to 7 μm. When the volume average particle size is less than 3 μm, sufficient fine particle flow cannot be obtained due to too small a volume average particle size, and there is a case where sufficient durability cannot be obtained. When the volume average particle size exceeds 8 μm, there is a case where highly precise images cannot be obtained.

Including toner F described above, so long as they are toners that can be controlled to maintain the state of color development or non-color development with light (or by not being irradiated with light), the toners can be used in the invention regardless of the constituting materials, the structure of the toner, and the mechanism of color development.

As the toners that can be used in the invention, volume average particle size distribution index GSDv is preferably 1.30 or less, and the ratio of volume average particle size distribution index GSDv to number average particle size distribution index GSDp (GSDv/GSDp) is preferably 0.95 or more.

More preferably volume average particle size distribution index GSDv is 1.25 or less, and the ratio of volume average particle size distribution index GSDv to number average particle size distribution index GSDp (GSDv/GSDp) is 0.97 or more.

When volume average particle size distribution index GSDv exceeds 1.30, there is a case where the resolution of images lowers, and when the ratio of volume average particle size distribution index GSDv to number average particle size distribution index GSDp (GSDv/GSDp) is less than 0.95, there is a case where the toner is accompanied by the reduction of charge, splashing of toner, the occurrence of fog, which result in image defect.

In the invention, the volume average particle size of the toner and the values of volume average particle size distribution index GSDv and number average particle size distribution index GSDp are measured and computed according to the following methods.

Measurement is performed with Coulter Multi-Sizer II (manufactured by Beckman Coulter Inc.). With the particle size distribution of the toner measured, the cumulative distribution of the volume and number of each particle are drawn from the smaller size side to the divided particle size range (channel), and particle size of accumulation of 16% is defined as volume average particle size D16v, and number average particle size as D16p, particle size of accumulation of 50% is defined as volume average particle size D50v, and number average particle size as D50p. Similarly, particle size of accumulation of 84% is defined as volume average particle size D84v, and number average particle size as D84p. At this time, volume average particle size distribution index (GSDv) is defined as (D84v/D16v)^{1/2}, and number average particle size distribution index GSDp is defined as (D84p/D16p)^{1/2}. Volume average particle size distribution index (GSDv) and number average particle size distribution index (GSDp) can be computed from the above relational expressions.

The volume average particle sizes of the above microcapsule and the photosensitive/heat-sensitive capsule can be measured with, e.g., laser diffraction particle size measuring instrument (LA-700, manufactured by Horiba, Ltd.).

The toner in the invention preferably has a shape factor SF1 represented by the following expression of from 110 to 130.

SF1=(ML²/A)×(π/4)×100 (1)

In expression (1), ML represents the maximum length (μm) of the toner, and A represents the projected area (μm²) of the toner.

When the shape factor SF1 is less than 110, in the transfer process in image formation, the toner is liable to remain on the surface of the image carrier, so that the removal of this residual toner is necessary, but the cleaning ability is liable to be impaired when the residual toner is cleaned with a blade and the like, as a result there is a case where image defect occurs.

On the other hand, when the shape factor SF1 exceeds 130 and the toner is used as the developer, there is a case where the toner is damaged by the impingement with the carrier in the developing apparatus. At this time, not only fine powders increase, the surface of the image carrier is contaminated with the releaser component bared on the toner surface, and charge characteristics are impaired, but also there is the possibility of the generation of fog ascribable to the fine powders.

Shape factor SF1 is measured as follows with an image analyzer LUZEX (FT, manufactured by NIRECO Corporation). The optical micrographic image of a toner sprayed on a slide glass is taken into the image analyzer LUZEX through a video camera, the maximum length (ML) and projected area (A) are measured with 50 or more toner particles, and the square root of the maximum length and the projected area of each toner particle are computed and shape factor SF1 is found from expression (1).

### <Developer>

Toner F may be used as it is as the one-component developer, but in the invention it is preferred to use as the toner in two-component developer including a carrier and a toner.

Here, from the point that a color image can be formed from one kind of developer, the developer may be (1) a developer of a type having one toner F having two or more color developing parts containing the photo-curable composition and microcapsules dispersed in the color developing part, and two or more color developing parts contained in toner F are capable of developing colors different from each other, or (2) a developer of s type having two or more toners having one color developing part containing the photo-curable composition and microcapsules dispersed in the photo-curable composition in a state of mixture, and two or more color developing parts of the toner are capable of developing colors different from each other.

For example, in the former type developer, three kinds of color developing parts are preferably contained in toner F, and the three kinds of color developing parts include a yellow color developing part capable of developing yellow color, a magenta color developing part capable of developing magenta color, and a cyan color developing part capable of developing cyan color. In the latter case of the developer, a yellow color developable toner whose color developing part is capable of developing yellow color, a magenta color developable toner whose color developing part is capable of developing magenta color, and a cyan color developable toner whose color developing part is capable of developing cyan color are contained in the developer as a mixed state.

As the carrier usable in the two-component developer, the core surface may be covered with resin. The materials of the core of the carrier are not especially restricted so long as the above conditions are satisfied, for example, magnetic metals, e.g., iron, steel, nickel, cobalt, etc., alloys of these magnetic metals with manganese, chromium, rare earth or the like, and magnetic oxides, e.g., ferrite, magnetite, etc., are exemplified. From the viewpoint of surface property and resistance of the core, ferrite is preferred, and alloys with manganese, lithium, strontium or magnesium are more preferred.

Further, the resins for covering core surface are not especially restricted so long as the resins can be used as the matrix resin, and arbitrarily selected according to purpose.

As the mixing ratio of toner F and the carrier (mass ratio) in the two-component developer, toner/carrier of from 1/100 to 30/100 or so is preferred, and from 3/100 to 20/100 or so is more preferred.

### TEST EXAMPLE

For the confirmation of the functions in the exemplary embodiments, the following tests are performed. In the examples, “parts” and “%” are respectively “parts by mass” and “mass %”.

A developer containing a toner (toner particles) is obtained as follows. In the following toner manufacture, the preparation of the photo-curable composition dispersions and series of manufacture of the toners are performed in the dark.

Toner 1: Manufacture of photo-non-color development type toner

### Preparation of Microcapsule Dispersion:

### —Microcapsule Dispersion (1)—

An electron donating leuco dye (1) capable of color developing in yellow (8.9 parts) is dissolved in 16.9 parts of ethyl acetate, and 20 parts of capsule wall material (Takenate D-110N, manufactured by Takeda Chemical Industries, Ltd.), and 2 parts of capsule wall material (Millionate MR200, manufactured by Nippon Polyurethane Industry Co., Ltd.) are further added thereto.

The obtained solution is added to a mixed solution containing 42 parts of 8% phthalated gelatin, 14 parts of water, and 1.4 parts of a 10% sodium dodecylbenzenesulfonate solution, and then the mixed solution is emulsified dispersed at 20° C. to obtain an emulsified liquid. After that, 72 parts of a 2.9% tetraethylenepentamine aqueous solution is added to the emulsified liquid, and the liquid is heated at 60° C. while stirring, and after 2 hours, microcapsule dispersion (1) having an average particle size of 0.5 μm containing electron donating leuco dye (1) on the core is obtained.

The glass transition temperature of the materials of the shell of microcapsules (the material obtained by the reaction of Takenate D-110N and Millionate MR200, almost on the same condition as above) contained in microcapsule dispersion (1) is 100° C.

### —Microcapsule Dispersion (2)—

Microcapsule dispersion (2) is obtained in the same manner as in the preparation of microcapsule dispersion (1), except for replacing electron donating leuco dye (1) with electron donating leuco dye (2). The average particle size of the microcapsules in the dispersion is 0.5 μm.

### —Microcapsule Dispersion (3)—

Microcapsule dispersion (3) is obtained in the same manner as in the preparation of microcapsule dispersion (1), except for replacing electron donating leuco dye (1) with electron donating leuco dye (3). The average particle size of the microcapsules in the dispersion is 0.5 μm.

The structural formulae of the electron donating leuco dyes (1) to (3) for use in the preparation of microcapsule dispersion are shown blow.

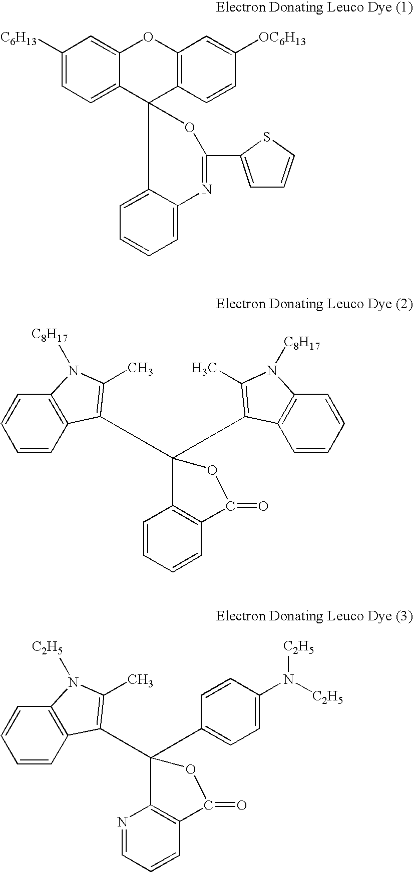

### Preparation of Photo-Curable Composition Dispersion

### —Photo-Curable Composition Dispersion (1)—

A mixture of electron accepting compounds (1) and (2) each having a polymerizable group (100.0 parts) (mixing ratio: 50/50), and 0.1 part of thermal polymerization inhibitor (ALI) are dissolved in 125.0 parts of isopropyl acetate (solubility in water: about 4.3%) at 42° C. to prepare mixed solution I.

To the mixture I are added 18.0 parts of hexaaryl-biimidazole (1) [2,2′-bis(2-chlorophenyl)-4,4′,5,5′-tetraphenyl-1,2′-biimidazole], 0.5 parts of nonionic organic dyestuff, and 6.0 parts of organic boron compound, and the mixed solution is heated at 42° C. to prepare mixed solution II.

The mixed solution II is added to a mixed solution containing 300.1 parts of an 8% gelatin aqueous solution and 17.4 parts of a 10% aqueous solution of surfactant (1), and the resulting solution is emulsified with a homogenizer (a product of Nippon Seiki Co., Ltd.) at 10,000 rpm for 5 minutes, and then is subjected to desolvation at 40° C. for 3 hours to obtain photo-curable composition dispersion (1) having solids content of 30%.

The structural formulae of electron accepting compound (1) having a polymerizable group, electron accepting compound (2) having a polymerizable group, thermal polymerization inhibitor (ALI), hexaarylbiimidazole (1) , surfactant (1), nonionic organic dyestuff, and organic boron compound for use in the preparation of photo-curable composition dispersion (1) are shown below.

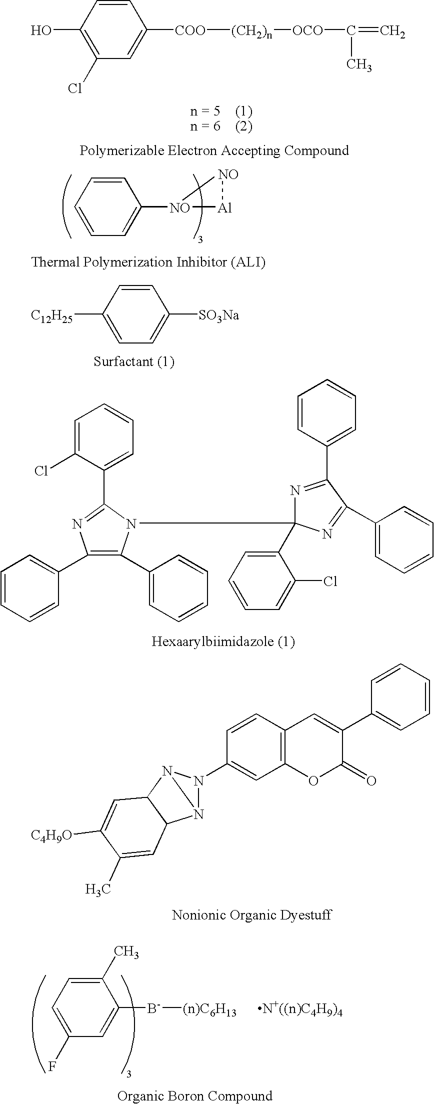

### —Photo-Curable Composition Dispersion (2)—

Into the mixed solution containing 0.6 parts of the following organic borate compound (I) (borate compound II), 0.1 part of the following spectral sensitizing dyestuff borate compound (I) (borate compound II), 0.1 part of the following adjuvant (1) for sensitization increase, and 3 parts of isopropyl acetate (the solubility in water: about 4.3%) is added 5 parts of the following electron accepting compound (3) having a polymerizable group.

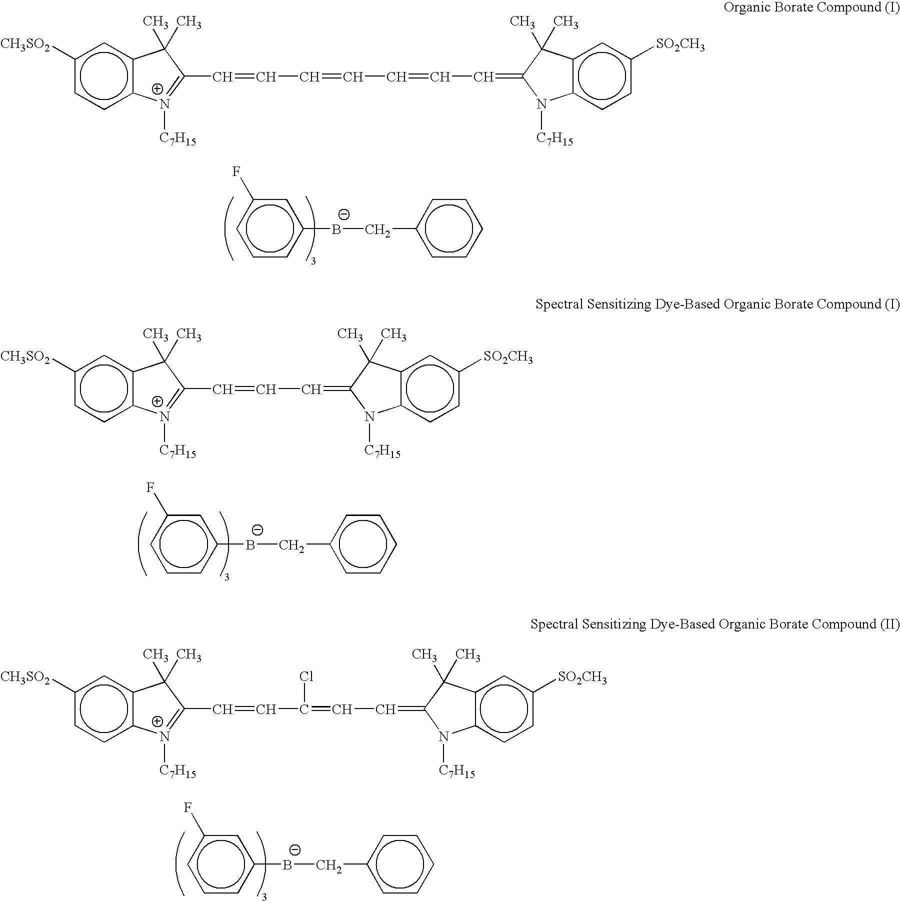

The obtained solution is added to a mixed solution containing 13 parts of a 13% gelatin aqueous solution, 0.8 parts of a 2% aqueous solution of the following surfactant (2), and 0.8 parts of a 2% aqueous solution of the following surfactant (3), and the resulting solution is emulsified with a homogenizer (a product of Nippon Seiki Co., Ltd.) at 10,000 rpm for 5 minutes to obtain a photo-curable composition dispersion (2).

The structural formulae of electron accepting compound (3) having a polymerizable group, adjuvant (1), surfactant (2), and surfactant (3) for use in the preparation of photo-curable composition dispersion (2) are shown below.

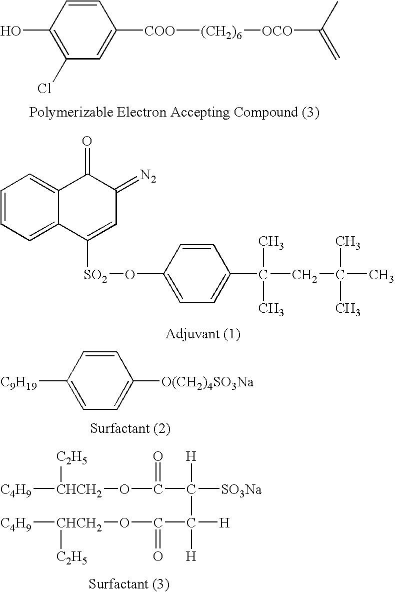

### —Photo-Curable Composition Dispersion (3)—

Photo-curable composition dispersion (3) is obtained in the same manner as in the preparation of photo-curable composition dispersion (2) except for using 0.1 part of spectral sensitizing dyestuff-based borate compound (II) (borate compound (II)) in place of spectral sensitizing dyestuff-based borate compound (I).

### Preparation of Resin Particle Dispersion

| | |
|---|---|
| Styrene | 460 parts |
| n-Butyl acrylate | 140 parts |
| Acrylic acid | 12 parts |
| Dodecanethiol | 9 parts |

A solution is prepared by mixing and dissolving the above components. Subsequently, 12 parts of an anionic surfactant (Dowfax, manufactured by Rhodia) is dissolved in 250 parts of ion exchange water, and the above solution is added thereto and dispersed and emulsified in a flask to prepare an emulsified liquid (monomer emulsified liquid A).

Further, 1 part of an anionic surfactant (Dowfax, manufactured by Rhodia) is dissolved in 555 parts of ion exchange water, and the solution is poured to a polymerization flask. The flask is sealed, reflux tube is installed, and the solution is slowly stirred while flowing nitrogen, the polymerization flask is heated with a water bath to 75° C., and is retained.

In the next place, a solution obtained by dissolving 9 parts of ammonium persulfate in 43 parts of ion exchange water is dropped to the polymerization flask for 20 minutes with a continuous flow pump, and then monomer emulsified liquid A is also dropped with the continuous flow pump for 200 minutes.

After that, while continuing stirring slowly, the polymerization flask is heated to 75° C. and retained for 3 hours, thus polymerization is terminated.

By the above polymerization reaction, a resin particle dispersion having a median particle size of 210 nm, a glass transition point of 51.5° C., a weight average molecular weight of 31,000, and solids content of 42% is obtained.

### Preparation of Toner 1 (Color Developing Part Dispersion Structure Type)

### —Preparation of Photosensitive/Heat-Sensitive Capsule Dispersion (1)—

| | |
|---|---|
| Microcapsule dispersion solution (1) | 150 parts |
| Photo-curable composition dispersion (1) | 300 parts |
| Polyaluminum chloride | 0.20 parts |
| Ion exchange water | 300 parts |

A raw material solution is obtained by dissolving the above components, and pH of the raw material solution is adjusted to 3.5 by adding nitric acid, and thoroughly mixed and dispersed with a homogenizer (ULTRA-TURRAX T50, manufactured by IKA), is poured to a flask and heated to 40° C. with a heating oil bath while stirring with a three-one motor, retained at 40° C. for 60 minutes, and further 300 parts of the resin particle dispersion is added, and the solution is slowly stirred at 60° C. for 2 hours to obtain photosensitive/heat-sensitive capsule dispersion (1).

The volume average particle size of the photosensitive/ heat-sensitive capsules dispersed in the dispersion is 3.53 μm. At preparation time of the dispersion, spontaneous color development is not confirmed.

### —Preparation of Photosensitive/Heat-Sensitive Capsule Dispersion (2)—

| | |
|---|---|
| Microcapsule dispersion (2) | 150 parts |
| Photo-curable composition dispersion (2) | 300 parts |
| Polyaluminum chloride | 0.20 parts |
| Ion exchange water | 300 parts |

Photosensitive/heat-sensitive capsule dispersion (2) is obtained in the same manner as in the preparation of photosensitive/heat-sensitive capsule dispersion (1) except for using the above components as the raw material solution.

The volume average particle size of the photosensitive/ heat-sensitive capsules dispersed in the dispersion is 3.52 μm. At preparation time of the dispersion, spontaneous color development is not confirmed.

### —Preparation of Photosensitive/Heat-Sensitive Capsule Dispersion (3)—

| | |
|---|---|
| Microcapsule dispersion (3) | 150 parts |
| Photo-curable composition dispersion (3) | 300 parts |
| Polyaluminum chloride | 0.20 parts |
| Ion exchange water | 300 parts |

Photosensitive/heat-sensitive capsule dispersion (3) is obtained in the same manner as in the preparation of photosensitive/heat-sensitive capsule dispersion (1) except for using the above components as the raw material solution.

The volume average particle size of the photosensitive/ heat-sensitive capsules dispersed in the dispersion is 3.47 μm. At preparation time of the dispersion, spontaneous color development is not confirmed.

### —Preparation of Toner—

| | |
|---|---|
| Photosensitive/heat-sensitive capsule | 750 parts |
| dispersion (1) | |
| Photosensitive/heat-sensitive capsule | 750 parts |
| dispersion (2) | |
| Photosensitive/heat-sensitive capsule | 750 parts |
| dispersion (3) | |

The solution that is obtained by mixing the above components is poured to a flask, and is heated to 42° C. with a heating oil bath while stirring, retained at 40° C. for 60 minutes, and further 100 parts of the resin particle dispersion is added, and the solution is slowly stirred.

The pH in the flask is adjusted to 5.0 with 0.5 mol/liter of sodium hydroxide aqueous solution, and the temperature is increased to 55° C. while stirring. During the time to increase temperature to 55° C., the pH in the flaks generally lowers to 5.0 or less, but here the pH not lower than 4.5 is retained by additionally dropping a sodium hydroxide aqueous solution. This condition is maintained at 55° C. for 3 hours.

After termination of the reaction, the reaction solution is cooled, filtered, thoroughly washed with ion exchange water, and solid liquid is separated by Nutsche suction filtration. The reaction solution is redispersed in 3 liters of ion exchange water at 40° C. in a 5 liter beaker, stirred at 300 rpm for 15 minutes, and washed. The washing operation is repeated 5 times, solid liquid is separated by Nutsche suction filtration, and then the reaction product is dried by freeze vacuum drying for 12 hours to obtain toner particles containing photosensitive/heat-sensitive capsules dispersed in the styrene resin. As a result of the measurement of the particle size of the toner particles with a Coulter counter, volume average particle size D50v is 15.2 μm. Subsequently, 1.0 part of hydrophobic silica (TS720, manufactured by Cabot Co., Ltd.) is added to 50 parts of the toner particles, and mixed with a sample mill to obtain outer addition toner 1.

Toner 2: manufacture of photo-color development type toner

### Preparation of Microcapsule Dispersion

### —Microcapsule Dispersion (1)—

The above electron donating leuco dye (1) (12.1 parts) is dissolved in 10.2 parts of ethyl acetate, and then 12.1 parts of dicyclohexyl phthalate, 26 parts of Takenate D-110N, (manufactured by Takeda Chemical Industries, Ltd.), and 2.9 parts of Millionate MR200 (manufactured by Nippon Polyurethane Industry Co., Ltd.) are added thereto to obtain a solution.

Subsequently, the solution is added to a mixed solution containing 5.5 parts of polyvinyl alcohol and 73 parts of water, and emulsified dispersed at 20° C. to obtain an emulsified liquid having an average particle size of 0.5 μm. To the obtained emulsified liquid is added 80 parts of water, and the liquid is heated at 60° C. while stirring, and after 2 hours, microcapsule dispersion (1) in which microcapsules containing electron donating leuco dye (1) as the core material are dispersed is obtained.

The glass transition temperature of the materials of the shell of microcapsules (the material obtained by the reaction of dicyclohexyl phthalate, Takenate D-110N and Millionate MR200, almost on the same condition as above) contained in microcapsule dispersion (1) is about 130° C.

### —Microcapsule Dispersion (2)—

Microcapsule dispersion (2) is obtained in the same manner as in the preparation of microcapsule dispersion (1), except for replacing electron donating leuco dye (1) with electron donating leuco dye (2).

### —Microcapsule Dispersion (3)—

Microcapsule dispersion (3) is obtained in the same manner as in the preparation of microcapsule dispersion (1), except for replacing electron donating leuco dye (1) with electron donating leuco dye (3).

### Preparation of Photo-Curable Composition Dispersion

### —Photo-Curable Composition Dispersion (1)—

To the solution obtained by dissolving 1.62 parts of photo-polymerization initiator (1-a) and 0.54 parts of (1-b) in 4 parts of ethyl acetate are added 9 parts of electron accepting compound (1) and 7.5 parts of trimethylolpropane triacrylate monomer (tri-functional acrylate, molecular weight: about 300).

The thus-obtained solution is added to a mixed solution containing 19 parts of a 15% PVA (polyvinyl alcohol) aqueous solution, 5 parts of water, 0.8 parts of a 2% aqueous solution of surfactant (1), and 0.8 parts of a 2% aqueous solution of surfactant (2) , the solution is emulsified with a homogenizer (a product of Nippon Seiki Co., Ltd.) at 8,000 rpm for 7 minutes to obtain photo-curable composition dispersion (1) of an emulsified liquid.

### —Photo-Curable Composition Dispersion (2)—

Photo-curable composition dispersion (2) is obtained in the same manner as in the preparation of photo-curable composition dispersion (1) except for replacing photo-polymerization initiators (1-a) and (1-b) with 0.08 parts of photo-polymerization initiator (2-a), 0.18 parts of (2-b), and 0.18 parts of (2-c).

### —Photo-Curable Composition Dispersion (3)—

Photo-curable composition dispersion (3) is obtained in the same manner as in the preparation of photo-curable composition dispersion (1) except for replacing photo-polymerization initiator (2-b) used in photo-curable composition dispersion (2) with photo-polymerization initiator (3-b).

The structural formulae of photo-polymerization initiators (1-a), (1-b), (2-a), (2-b), (2-c), (3-b), electron accepting compound (1), and surfactants (1) and (2) used in the preparation of the photo-curable composition dispersion are shown below.

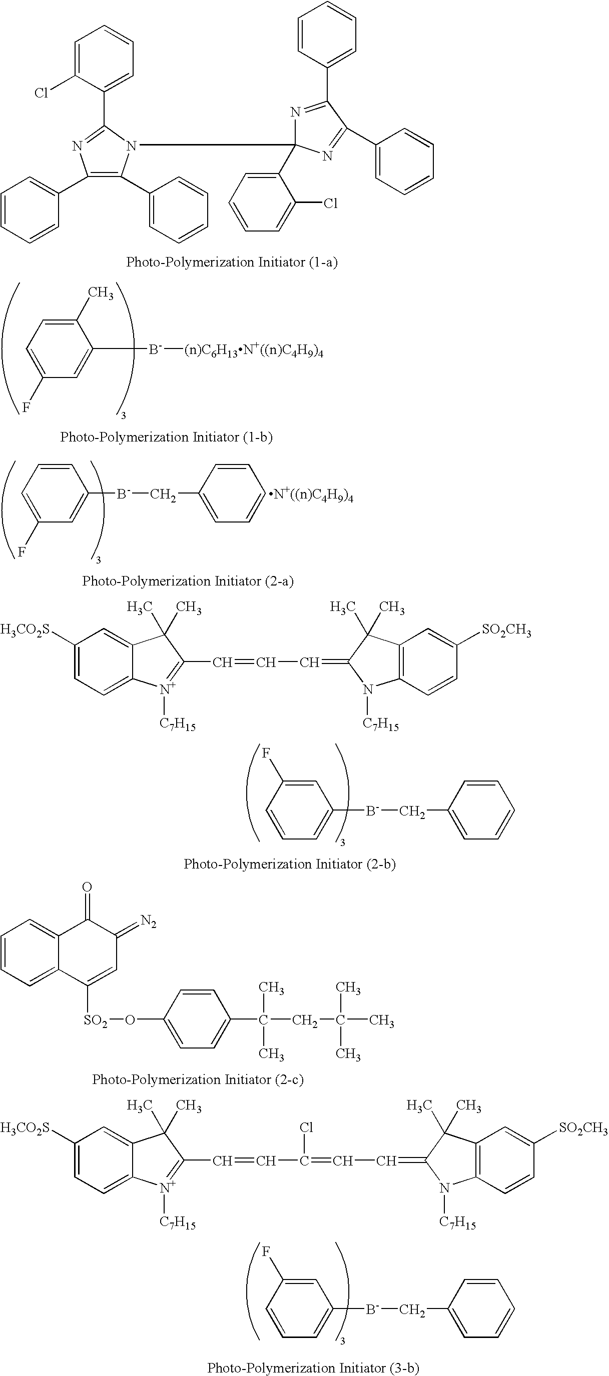

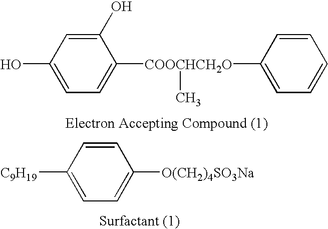

Surfactant (2)

C₁₂H₂₅SO₃Na

### —Preparation of Resin Particle Dispersion (1)—

| | |
|---|---|
| Styrene | 360 parts |
| n-Butyl acrylate | 40 parts |
| Acrylic acid | 4 parts |
| Dodecanethiol | 24 parts |
| Carbon tetrabromide | 4 parts |

A solution is prepared by mixing and dissolving the above components. Subsequently, 6 parts of a nonionic surfactant (Nonipol 400, manufactured by Sanyo Chemical Industries, Ltd.), and 10 parts of anionic surfactant (Neogen SC, manufactured by DAI-ICHI KOGYO SEIYAKU CO., LTD.) are dissolved in 560 parts of ion exchange water, and the above solution is added thereto and dispersed and emulsified in a flask, and, while slowly mixing for 10 minutes, 50 part of ion exchange water having dissolved 4 parts of ammonium persulfate is poured into the above emulsified liquid.

Subsequently, after nitrogen substitution in the flask, while stirring the content of the flask, the reaction solution is heated with an oil bath until the content reaches 70° C., and emulsion polymerization is continued for 5 hours to thereby obtain resin particle dispersion (1) (resin particle concentration: 30%) containing the resin particles dispersed, having a volume average particle size of 200 nm, a glass transition temperature of 50° C., weight average molecular weight (Mw) of 16,200, and a specific viscosity of 1.2.

### —Preparation of Photosensitive/Heat-Sensitive Capsule Dispersion (1)—

| | |
|---|---|
| Microcapsule dispersion (1) | 24 parts |
| Photo-curable composition dispersion (1) | 232 parts |

The above components are thoroughly mixed and dispersed in a rounded stainless steel flask with ULTRA-TURRAX T50 (manufactured by IKA).

pH is adjusted to 3 with nitric acid, 0.20 parts of polyaluminum chloride is added thereto, and dispersing with ULTRA-TURRAX at 6,000 rpm is continued for 10 minutes. The solution is heated to 40° C. with an oil bath for heating while stirring the flask slowly.

Here, 60 parts of resin particle dispersion (1) is added slowly.

Thus, photosensitive/heat-sensitive capsule dispersion (1) is obtained. The volume average particle size of the photosensitive/heat-sensitive capsules dispersed in the dispersion is about 2 μm. Spontaneous color development of the obtained dispersion is not confirmed.

### —Preparation of Photosensitive/Heat-Sensitive Capsule Dispersion (2)—

Photosensitive/heat-sensitive capsule dispersion (2) is prepared in the same manner as in the preparation of Photosensitive/heat-sensitive capsule dispersion (1), except for replacing microcapsule dispersion (1) with microcapsule dispersion (2) and replacing photo-curable composition dispersion (1) with photo-curable composition dispersion (2). The volume average particle size of the photosensitive/heat-sensitive capsules dispersed in the dispersion is about 2 μm. Spontaneous color development of the obtained dispersion is not confirmed.

### —Preparation of Photosensitive/Heat-Sensitive Capsule Dispersion (3)—

Photosensitive/heat-sensitive capsule dispersion (3) is prepared in the same manner as in the preparation of Photosensitive/heat-sensitive capsule dispersion (1), except for replacing microcapsule dispersion (1) with microcapsule dispersion (3) and replacing photo-curable composition dispersion (1) with photo-curable composition dispersion (2). The volume average particle size of the photosensitive/heat-sensitive capsules dispersed in the dispersion is about 2 μm. Spontaneous color development of the obtained dispersion is not confirmed.

### Preparation of Toner 2 (Color Developing Part Dispersion Structure Type)

### —Preparation of Toner—

| | |
|---|---|
| Photosensitive/heat-sensitive capsule | 80 parts |
| dispersion (1) | |
| Photosensitive/heat-sensitive capsule | 80 parts |
| dispersion (2) | |
| Photosensitive/heat-sensitive capsule | 80 parts |
| dispersion (3) | |
| Resin particle dispersion (1) | 80 parts |

The above components are thoroughly mixed and dispersed in a rounded stainless steel flask with ULTRA-TURRAX T50 (manufactured by IKA).

To the above reaction mixture is added 0.1 part of polyaluminum chloride, and dispersing with ULTRA-TURRAX at 6,000 rpm is continued for 10 minutes. The solution is heated to 48° C. with an oil bath for heating while stirring the flask and retained at 48° C. for 60 minutes. Here, 20 parts of resin particle dispersion (1) is added slowly.

After that, pH in the system is adjusted to 8.5 with 0.5 mol/liter of sodium hydroxide aqueous solution, the stainless steel flask is sealed, and stirring is continued with a magnetic seal while heating to 55° C. and retained for 10 hours.

After termination of the reaction, the reaction solution is cooled, filtered, thoroughly washed with ion exchange water, and solid liquid is separated by Nutsche suction filtration. The reaction solution is redispersed in 1 liter of ion exchange water at 40° C., stirred at 300 rpm for 15 minutes, and washed.

The washing operation is repeated 5 times, and when pH of filtrate is adjusted to 7.5 and the conductivity reaches 7.0 μS/cmt, solid liquid is separated with No. 5A filter paper by Nutsche suction filtration, and then the reaction product is dried by vacuum drying for 12 hours to obtain toner particles containing three kinds of photosensitive/heat-sensitive capsules dispersed in the matrix.

As a result of the measurement of the particle size of the toner particles with a Coulter counter, volume average particle size D50v is about 15 μm. Spontaneous color development of the obtained dispersion is not confirmed.

Subsequently, 100 parts of the obtained toner, 0.3 parts of hydrophobic titania having an average particle size of 15 nm surface-treated with n-decyltrimethoxysilane, and 0.4 parts of hydrophobic silica (NY50, manufactured by Nippon Aerosil Co., Ltd.) having an average particle size of 30 nm are blended with a Henschel mixer at a peripheral speed of 32 m/s for 10 minutes, and then coarse particles are removed with a sieve having opening of 45 μm to obtain outer addition toner 2 added with outer additives.

Toner 3: Preparation of black coloring toner

### —Resin Particle Dispersion—

A solution is obtained by mixing and dissolving 370 parts of styrene, 30 parts of n-butyl acrylate, 8 parts of acrylic acid, 12 parts of dodecanethiol, and 2 parts of divinyl adipate, and the solution is added to a solution obtained by dissolving 6 parts of a nonionic surfactant (Nonipol 400, manufactured by Sanyo Chemical Industries, Ltd.), and 10 parts of an anionic surfactant (Neogen SC, manufactured by DAI-ICHI KOGYO SEIYAKU CO., LTD.) in 583 parts of ion exchange water, and dispersed and emulsified in a flask while slowly mixing for 10 minutes, and 50 part of ion exchange water having dissolved 4 parts of ammonium persulfate is poured into the above emulsified liquid. Subsequently, after nitrogen substitution in the flask, while stirring the content of the flask, the reaction solution is heated with an oil bath until the content reaches 70° C., and emulsion polymerization is continued for 5 hours.

Thus, resin particle dispersion containing the resin particles dispersed, having a volume average particle size of 150 nm, Tg of 56° C., weight average molecular weight (Mw) of 3,000 is obtained. The solid content concentration of the dispersion is 40%.

### —Colorant Dispersion—

| | |
|---|---|
| Carbon black (Mogul L, manufactured by Cabot Co., Ltd.) | 60 parts |
| Nonionic surfactant (Nonipol 400 manufactured by Sanyo | 6 parts |
| Chemical Industries, Ltd.) | |
| Ion exchange water | 240 parts |

The above components are mixed and dissolved, and stirred with a homoggenizer (ULTRA-TURRAX T50, manufactured by IKA) for 10 minutes, and is then dispersion treated with Ultimaizer to obtain colorant dispersion (1) dispersed with the colorant (carbon black) particles having an average particle size of 250 nm.

### —Releaser Dispersion—

| | |
|---|---|
| Paraffin wax (HNP0190, melting point: 85° C. manufactured | 100 parts |
| by NIPPON SEIRO CO., LTD.) | |
| Cationic surfactant (SANISOL B50, manufactured by Kao | 5 parts |
| Corporation) | |
| Ion exchange water | 240 parts |

The above components are dispersed in a rounded stainless steel flask with a homogenizer (ULTRA-TURRAX T50, manufactured by IKA) for 10 minutes, and then dispersion treated with a pressure discharge type homogenizer to prepare a releaser dispersion dispersed with releaser particles having an average particle size of 550 nm.

### —Preparation of Black Coloring Toner Particles—

| | |
|---|---|
| Resin particle dispersion | 234 parts |
| Colorant dispersion | 30 parts |
| Releaser dispersion | 40 parts |
| Polyaluminum hydroxide (Paho2S, manufactured by Asada | 0.5 parts |
| Chemical Industry Co., Ltd.) | |
| Ion exchange water | 600 parts |

The above components are mixed and dispersed in a rounded stainless steel flask with a homogenizer (ULTRA-TURRAX T50, manufactured by IKA), and then heated to 40° C. in a heating oil bath while stirring the content of the flask. On retaining at 40° C. for 30 minutes, coagulated particles having an average particle size of 4.5 μm is confirmed. When the temperature of the oil bath is increased and retained at 56° C. for 1 hour, the average particle size became 5.3 μm. After that, 26 parts of the resin particle dispersion is added to the dispersion containing the coagulated particles, the temperature of the heating oil bath is lowered to 50° C., and retained for 30 minutes.

To the dispersion containing the coagulated particles is added 1N sodium hydroxide to adjust pH to 7.0, the stainless steel flask is sealed and stirring is continued with a magnetic seal, the temperature is increased to 80° C. and retained for 4 hours. After cooling, the reaction product is filtered, washed with ion exchange water 4 times and freeze-dried to obtain black coloring toner particles having Tg of 54° C., a volume average particle size of 5.9 μm, and a shape factor SF1 of 132.

Subsequently, 100 parts of the obtained black coloring toner, 0.3 parts of hydrophobic titania having an average particle size of 15 nm surface-treated with n-decyltrimethoxy-silane, and 0.4 parts of hydrophobic silica (NY50, manufactured by Nippon Aerosil Co., Ltd.) having an average particle size of 30 nm are blended with a Henschel mixer at a peripheral speed of 32 m/s for 10 minutes, and then coarse particles are removed with a sieve having opening of 45 μm to obtain outer addition toner 3 added with outer additives.

### Manufacture of Developer

As the carrier, 30 mass % of styrene/acryl copolymer (number average molecular weight: 23,000, weight average molecular weight: 98,000, Tg: 78° C.), and 70 mass % of particulate magnetite (maximum magnetization: 80 emu/g, average particle size: 0.5 μm) are kneaded, pulverized, and classified. By using the particles having a volume average particle size of 100 μm, and the above toner particles 1 to 3 weighed so that have toner concentration of 5 mass %, and mixed with a ball mill for 5 minutes to obtain developers 1 to 3.

### TEST EXAMPLE 1

With the image-forming apparatus having the similar construction as in the first exemplary embodiment (see FIG. 1), developer 1 (developer containing a photo-non-color development type toner) is loaded on first developing apparatus 14A in first image-forming unit 10A, and developer 3 (developer containing a black coloring toner) is loaded on second developing apparatus 14B in second image-forming unit 10B.

As first photoconductor 11A and second photoconductor 11B, an aluminum drum having a diameter of 30 mm having formed thereon by coating multilayer organic photosensitive layer having a thickness of 25 μm including a charge-generating layer of gallium phthalocyanine chloride, and a charge transporting layer of N,N′-diphenyl-N,N′-bis(3-methylphenyl)-[1,1′]biphenyl-4,4′-diamine are used.

As first charger 12A and second charger 12B, Scorotron is used.

As first exposing apparatus 13A and second exposing apparatus 13B, LED image bar having wavelength of 780 nm capable of forming a latent image having resolution of 600 dpi is used.

First developing apparatus 14A and second developing apparatus 14B are equipped with a metal sleeve for two-component magnetic brush development capable of reversal development. The charge amount of the toner at the time when the developers are loaded into the developing apparatuses is −5 to −30 μC/g or so.

As color forming information-applying apparatus 15A, LED image bar capable of emitting lights of peak wavelength of 405 nm (exposure amount: 0.2 mJ/m²), 532 nm (exposure amount: 0.2 mJ/m²), and 657 nm (exposure amount: 0.4 mJ/m²) and having resolution of 600 dpi is used.

As first transfer apparatus 16A and second transfer apparatus 16B, a semiconductive roll having an elastic core material covered around the periphery with conductive elastic body is used. The conductive elastic body is a non-compatible blend of NBR and EPDM, and dispersed therein two kinds of carbon blacks of ketchen black and thermal black, roll resistance is 10^{8.5} Ωcm, and ASKER-C hardness is 35°.

As intermediate transfer belt 20, a polymide film having a thickness of 0.08 mm blended with carbon black (Young's modulus: 3,800 MPa, volume resistivity: 1×10^{9.5} Ωcm, surface resistivity: 1×10¹² Ω/□) is used.

As third transfer apparatus 21, a semiconductive roll having an elastic core material covered around the periphery with conductive elastic body is used. The conductive elastic body is a non-compatible blend of NBR and EPDM, and dispersed therein two kinds of carbon blacks of ketchen black and thermal black, roll resistance is 10^{8.5} Ωcm, and ASKER-C hardness is 35°.

As fixing apparatus 22, the fixing apparatus used in DPC1616 (manufactured by Fuji Xerox Co., Ltd.) is used, and is arranged at the position 30 cm from the point of color forming information application.

As photo-irradiation apparatus 23, high intensity Schaukasten including three wavelengths of the color forming information application apparatus is used, and the width of irradiation is 5 mm.

With the image forming apparatus having the above construction, printing conditions are as follows.

### —First Image Forming Unit Conditions—

Linear speed of the photoconductor: 10 mm/sec
Charge condition: −400 V is applied to Scorotron screen, and DC −6 kV to the wire. At this time the surface potential of the photoconductor is −400 V.
Exposure: Exposure is performed with black image data, and the potential after exposure is about −50 V.
Development bias: Short wave of AC Vpp 1.2 kV (3 kHz) is superposed to DC −330 V.
Development contact condition: Peripheral ratio (development roll/photoconductor) is 2.0, development gap is 0.5 mm, the weight of developer on the developing roll is 400 g/m², and the toner development amount on the photoconductor is set to be 5 g/m² as solid image.
Transfer bias to the intermediate transfer belt: application of DC of +800 V.

### —Second Image Forming Unit Conditions—

Linear speed of the photoconductor: 10 mm/sec
Charge condition: −400 V is applied to Scorotron screen, and DC −6 kV to the wire. At this time the surface potential of the photoconductor is −400 V.
Exposure: Exposure is performed by logical sum of image-forming data of three colors of C, M and Y, and the potential after exposure is about −50 V.
Development bias: Short wave of AC Vpp 1.2 kV (3 kHz) is superposed to DC −330 V.
Development contact condition: Peripheral ratio (development roll/photoconductor) is 2.0, development gap is 0.5 mm, the weight of developer on the developing roll is 400 g/m², and the toner development amount on the photoconductor is set to be 5 g/m² as solid image.
Transfer bias to the intermediate transfer belt: application of DC of +800 V.

### —Other Conditions—

Transfer bias to the recording medium: application of DC of +1 V
Fixing temperature: Surface temperature of fixing roll is set at 180° C.
Intensity of irradiation apparatus: 130,000 lux

On the above conditions, a chart having image gradation of each color of Y, M, C, R, G, B and K is printed. The application of color forming information to toner F is performed by the following shown combination (in the following tables, when LED with mark o emits, the toner develops a desired color). For controlling color development density by irradiation strength or irradiation time, time width modulation of dividing the time of 1 dot by 8 is adopted. Black is not tested in this test example, and a black image is formed with the black coloring toner.

TABLE 1

| | Developed Colors | | | | | | | |
|---|---|---|---|---|---|---|---|---|
| LED Wavelength | Y | M | C | R | G | B | K | W |
| 405 nm | | ◯ | ◯ | | | ◯ | | ◯ |
| 532 nm | ◯ | | ◯ | | ◯ | | | ◯ |
| 657 nm | ◯ | ◯ | | ◯ | | | | ◯ |

### Image Evaluation

Each print sample obtained on the conditions described above is evaluated as follows.

### —Color Development Density—

With each color of Y, M and C, the image density of image area is measured with densitometer X-Rite 938 (manufactured by X-Rite). Every color shows sufficient image density of 1.5 or more. As a result of measurement of K (black) in the same manner, sufficient image density of 1.7 or more is observed.

### —Color Reproducibility—

Color reproducibility of each of R, G, B and K is measured with a gradation chart of from 56 to 100% with every 5%, any color shows good color balance and excellent in color reproducibility.

### —Reproducibility of High Light Image—

As a result of examination of reproducibility of high light image with a half tone image of entire print surface of 15% shows no jumping in the high light part and good print.

### COMPARATIVE EXAMPLE 1

The evaluation is performed in the same manner as in test example 1, except that the chart having gradation image is printed with each color of Y, M, C, R, G, B and K with only first image-forming unit 10A using toner F. The application of color forming information to toner F is performed according to the combination shown in the following Table 1.

As a result, the image density, color reproducibility, and high light image reproduction of K (black) are all inferior to Test Example 1. After forming the prescribed image, the measured amount of the consumption of the toner is about three times that in Test Example 1.

### TEST EXAMPLE 2

The image formation and evaluation are performed in the same manner as in image formation in Test Example 1, except for changing the linear speed of first photoconductor 11A and second photoconductor 11B to 300 mm/sec. The fixing apparatus and photo-irradiation apparatus are taken out and non-fixed image is outputted under the condition and, after the apparatus is allowed to stand in the dark for 10 minutes, fixing, irradiation and image formation are performed at the same linear speed and temperature.

As a result of evaluation, color development density, color reproducibility, and high light image part reproduction are substantially the same as in Test Example 1 regardless of allowing to stand or not.

### TEST EXAMPLE 3

The image formation and evaluation are performed in the same manner as in image formation in Test Example 1, except for changing the developer 1 in first image forming unit 10A to developer 2, and the application of color forming information to toner F is changed to the combination in Table 2 below. Black is not tested in this test example, and a black image is formed with the black coloring toner.

As a result of evaluation, color development density is 1.5 or more, and the color development density of black image part is 1.7 or more, and the color reproducibility and high light image part reproduction are substantially the same as in Test Example 1 by visual observation. When the photo-color development type toner is used, similarly to the case of using the photo-non-color development type toner in Test Example 1, excellent characteristics can be obtained in color development density, color reproduction and high light part reproduction.

TABLE 2

| | Developed Colors | | | | | | | |
|---|---|---|---|---|---|---|---|---|
| LED Wavelength | Y | M | C | R | G | B | K | W |
| 405 nm | ◯ | | | ◯ | ◯ | | ◯ | |
| 532 nm | | ◯ | | ◯ | | ◯ | ◯ | |
| 657 nm | | | ◯ | | ◯ | ◯ | ◯ | |

### TEST EXAMPLE 4

As the image evaluation is performed in the same manner as in Test Example 1, except for changing first photoconductor 11A in first image forming unit 10A as shown below, and arranging first exposing apparatus 13A in the inside of first photoconductor 11A so as to be capable of exposure from the rear side of first photoconductor 11A, the same result can be obtained. Further, in this test example, as compared with Test Example 1, the deterioration of photoconductor is less, and image deterioration is not caused even with printing of 20 k or more.
First photoconductor 11A: as the conductive support, a transparent glass substrate having a diameter of 30 mm is provided with a conductive layer by ITO sputtering, on the conductive layer, multilayer organic photosensitive layer having a thickness of 25 μm including a charge-generating layer of gallium phthalocyanine chrolide, and a charge transporting layer of N,N′-diphenyl-N,N′-bis(3-methylphenyl)-[1,1′]biphenyl-4,4′-diamine are formed by coating as the photosensitive layer, and surface layer 111D is formed by dip method with acryl-modified polyurethane in a thickness of 2 μm.

### TEST EXAMPLE 5

As the image evaluation is performed in the same manner as in Test Example 1, except for replacing first photoconductor 11A with the dielectric drum as shown below, and replacing first exposure apparatus 13A with the ionic writing apparatus 19A shown below in first image forming unit 10A, the same result can be obtained. Further, in this test example, as compared with Test Example 1, the deterioration of dielectric that is an image carrier is less, and image deterioration is not caused even with printing of 100 k or more.
Dielectric drum 18A: a dielectric drum is a drum having a transparent dielectric layer (acrylic resin layer) having a thickness of 20 μm formed on the surface of a metal drum such as aluminum (reflectance: 95%) having a diameter of 30 mm.
Ionic writing apparatus 19A: an ion flow control head having control slits (control electrode with slits) formed having resolution of 600 dpi on the entire surface of a corona charger (e.g., ion generator). Ionic writing apparatus controls the control slits responding to the image of the logical sum of image-forming data of three colors of Y, M and C, applies voltage of 8 kV to ion generator (a corona charger) to apply plus ions and forms a latent image.

As described above, in an image forming apparatus (image forming method) using toner F and a black coloring toner, the image density of a black image is high, in addition, consumption of the toner is low, therefore, running costs can be reduced.

When the linear speed of first photoconductor 11A and second photoconductor 11B is largely varied, change in image is not seen and stable, and reproducibility of a high light image area is also good, therefore, it can be seen that images of high quality can be obtained.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An image-forming apparatus comprising:
a first image-forming unit using a color forming control toner that is controlled to maintain the state of color development or non-color development by the application of color forming information by light, including a first image carrier, a first toner image-forming unit that forms a first toner image on the surface of the first image carrier with a first developer containing the color forming control toner, a color forming information-applying unit that gives color forming information by light to the first toner image, and a first transfer unit that transfers the first toner image formed on the surface of the first image carrier to the surface of an intermediate transfer body,
a second image-forming unit using a black coloring toner, including a second image carrier, a second toner image-forming unit that forms a second toner image on the surface of the second image carrier with a second developer containing the black coloring toner, and a second transfer unit that transfers the second toner image formed on the surface of the second image carrier to the surface of an intermediate transfer body,
an intermediate transfer body to which the first toner image and the second toner image respectively formed in the first image-forming unit and the second image-forming unit are transferred,
a third transfer unit that transfers the first toner image and the second toner image transferred to the surface of the intermediate transfer body to a recording medium,
a fixing unit that fixes the first toner image and the second toner image transferred to the surface of the recording medium, and
a color forming unit that forms the color of the first toner image that is applied with the color forming information.

2. The image-forming apparatus according to claim 1, wherein the first image carrier is a photoconductor, and the first toner image-forming unit comprises a first charging unit that charges the surface of the photoconductor, a first exposing unit that forms an electrostatic latent image on the surface of the photoconductor by exposure, and a first developing unit that develops the electrostatic latent image with the color forming control toner to form a first toner imagecolor forming control.

3. The image-forming apparatus according to claim 2, wherein the photoconductor includes a conductive support, a photosensitive layer, and a surface layer laminated from the inside periphery to the outside peripheral side, and the conductive support has transparency to light outgoing from the first exposing unit, and the surface layer has opacity to light outgoing from the color forming information-applying unit,
the first exposing unit is arranged on the rear side of the photoconductor to perform exposure from the rear side of the photoconductor, and
the color forming information-applying unit is arranged on the front side of the photoconductor to perform exposure from the front side of the photoconductor.

4. The image-forming apparatus according to claim 1, wherein the first image carrier is a dielectric, and
the first toner image-forming unit comprises a first charging unit that charges the surface of the dielectric, an ion writing unit that forms a latent image by applying ions having reverse polarity to the charge of the dielectric to the surface of the dielectric, and a first developing unit that makes the electrostatic latent image a first toner image with the color forming control toner.

5. The image-forming apparatus according to claim 1, wherein the fixing unit is the color forming unit.

6. The image-forming apparatus according to claim 1, further comprising a light-irradiation unit that irradiates the surface of the recording medium after fixing.

7. The image-forming apparatus according to claim 1, wherein the color forming control toner includes a first component and a second component that are present in the state of being separated from each other, and form color when reacted with each other, and a photo-curable composition containing at least one of the first component and the second component, maintains the photo-curable composition in the state of curing or not curing by the application of color forming information by light, and is controlled in the reaction for forming the color.

8. An image-forming method comprising:
forming a first toner image using a first developer containing a color forming control toner on the surface of a first image carrier, the color forming control toner being controlled to maintain the state of color forming or non-color forming by the application of color forming information by light, applying the color forming information by light to the first toner image, and transferring the first toner image formed on the surface of the first image carrier to the surface of an intermediate transfer body,
second image-forming forming a second toner image using a second developer containing a black coloring toner on the surface of a second image carrier, and transferring the second toner image formed on the surface of the second image carrier to the surface of the intermediate transfer body,
transferring the first toner image and the second toner image transferred to the surface of the intermediate transfer body to a recording medium,
fixing the first toner image and the second toner image transferred to the surface of the recording medium, and
forming the color of the first toner image that is applied with the color forming information.

9. A toner comprising a coupler, and a photo-curable coloer former monomer capable of being colored upon reaction with the coupler.

10. The toner as claimed in claim 9, wherein
the coloring agent and the photo-curable coloer former monomer are separated from each other in the toner, and
a polymer formed through photopolymerization of the photo-curable coloer former monomer is contained in the toner to prevent from being reacted with the coupler.

11. The toner as claimed in claim 9, wherein
at least one of the coupler and the photo-curable coloer former monomer are contained in a microcapsule, and
a polymer formed through photopolymerization of the photo-curable coloer former monomer dose not pass a wall of the microcapsule.

12. The toner as claimed in claim 9, wherein
the coupler is selected from an electron donating leuco dye and a diazonium salt compound, and
the photo-curable coloer former monomer is selected from an electron accepting compound and a coupler compound having a photo-polymerizable group.

13. The toner as claimed in claim 12, wherein
the coupler is an electron donating leuco dye, and
a content of the electron donating leuco dye at a color developing part in the toner is from about 0.01 to about 3 g/m².

14. The toner as claimed in claim 12, wherein
the coupler is an electron donating leuco dye, and the photo-curable coloer former monomer is a coupler compound having a photo-polymerizable group, and
the coupler compound is contained in an amount of from about 0.5 to about 20 parts by mass per 1 part by mass of the electron donating leuco dye.

15. The toner as claimed in claim 12, wherein
the coupler is a diazonium salt compound, and
a content of the diazonium salt compound at a color developing part in the toner is from about 0.01 to about 3 g/m².

16. The toner as claimed in claim 12, wherein
the coupler is a diazonium salt compound, and the photo-curable coloer former monomer is a coupler compound having a photo-polymerizable group, and
the coupler compound is contained in an amount of from about 0.5 to about 20 parts by mass per 1 part by mass of the diazonium salt compound.

17. The toner as claimed in claim 9, wherein
the toner further comprises a spectral sensitizing dyestuff and a borate compound, and a ratio of the spectral sensitizing dyestuff to the borate compound in the toner is in a range of from about 1/1 to about 1/50.

18. The toner as claimed in claim 9, wherein
the toner has GSDv of about 1.30 or less, GSDv/GSDp of about 0.97 or more, and SF1 of from about 110 to about 130.

19. A toner comprising a coupler, a color former capable of being colored upon reaction with the coupler, and a photo-polymerizable monomer.

20. The toner as claimed in claim 19, wherein
the coupler and the color former are separated from each other in the toner, and
the photo-polymerizable monomer undergoes photo-polymerization to form a polymer, whereby the coupler and the color former are reacted to each other to form the color.

21. The toner as claimed in claim 19, wherein
at least one of the coupler and the color former are contained in the microcapsule.

22. The toner as claimed in claim 20, wherein
the photo-polymerizable monomer contains decoloration reacting group capable of inhibiting coloration reaction between the coupler and the color former.

23. The toner as claimed in claim 19, wherein
the coupler is a polymerizable compound having an ethylenic unsaturated bond, and
the color former is selected from a phenol derivative, an organic carboxylic acid derivative and a metal salt thereof, a sulfonic acid derivative, urea and thiourea derivatives, acid clay, bentonite, a novolak resin and a metal complex.

24. The toner as claimed in claim 19, wherein
the toner further comprises a thermal polymerization inhibitor.

25. The toner as claimed in claim 19, wherein
the toner has GSDv of about 1.30 or less, GSDv/GSDp of about 0.97 or more, and SF1 of from about 110 to about 130.
